(19) United States
(12) Patent Application Publication
(10) Pub. No.: US 2026/0300337 A1
(43) Pub. Date: Oct. 1, 2026

(54) SUPPORT SERVICE SYSTEM WITH SUPPLEMENTAL NATURAL LANGUAGE QUESTION GENERATION USING A GENERATIVE SERVICE

(71) Applicant: Atlassian Pty Ltd., Sydney (AU)

(72) Inventors: Nisha Iyer, Washington, DC (US); Joseph Andrew DeGregorio, Seattle, WA (US); Thomas Andrew Albrecht, Elizabethtown, KY (US)

(21) Appl. No.: 19/094,650

(22) Filed: Mar. 28, 2025

(51) Int. Cl. G06F 16/3329; G06F 16/3332

(52) U.S. Cl. CPC G06F 16/33295; G06F 16/3334

(57) ABSTRACT

A computer-implemented method may generate questions in response to a user input, where the questions are configured to elicit additional information that is specifically relevant to solving or otherwise satisfying the user's input.

### TECHNICAL FIELD

The present disclosure is generally directed to support interactions, and more particularly, to systems and methods for automatically generating follow-up questions to a user's natural language input during a support interaction.

### BACKGROUND

Modern electronic devices facilitate a myriad of uses, both for business and personal endeavors. For example, electronic devices like personal computers, tablets, mobile phones, are used in both business and personal contexts for creating and storing documents, writing computer code, communicating with other individuals (e.g., via email, chat services, voice and video calls, etc.), and the like. Increasingly, electronic devices are used to facilitate support interactions, such as for technical support relating to computer software.

### SUMMARY

A computer-implemented method of generating questions in response to a user input may include receiving a natural language input from a graphical user interface of a client application operating on a client device, analyzing the natural language input using a support-request analysis engine to determine a sufficiency condition, in accordance with a determination that the sufficiency condition is not satisfied, generating a set of recommended data item queries, analyzing the set of recommended data item queries to identify a group of data item queries for which answers were not included in the natural language input, analyzing the identified group of data item queries to identify redundant data item queries that are directed to eliciting same information, generating a representative data item query for the redundant data item queries, including the representative data item query in the identified group of data item queries, and for a data item query of the identified group of data item queries, generating a natural language query string for eliciting, from a user, an answer to the data item query, including generating a question generation prompt including predetermined query prompt text and the data item query, providing the question generation prompt to a generative output engine, and receiving the natural language query string from the generative output engine. The method may further include causing display of the natural language query string to the user, receiving, from the user, a response including the answer to the data item query, generating an issue record including the answer to the data item query, and storing the issue record in association with an issue tracking system.

The predetermined query prompt text may be predetermined first query prompt text, and generating the representative data item query for the redundant data item queries may include generating a representative data item query prompt including predetermined second query prompt text and text from the redundant data item queries, providing the representative data item query prompt to the generative output engine, and receiving the representative data item query from the generative output engine.

The method may further include removing, from the identified group of data item queries, data item queries that may be not supported by a support-request interaction type associated with the natural language input, thereby creating a list of candidate data item queries, and selecting the data item query from the list of candidate data item queries.

The predetermined query prompt text may be predetermined first query prompt text, and generating the set of recommended data item queries may include submitting a first request to a first service to obtain a first subset of recommended data item queries, and submitting a second request to a knowledge-base service to obtain a second subset of recommended data item queries. The second subset of recommended data item queries generated by identifying a knowledge base document of a set of knowledge base documents, generating a data item query prompt including predetermined second query prompt text, text from the knowledge base document, and the natural language input, providing the data item query prompt to a generative output engine, and receiving, from the generative output engine, the second subset of recommend data item queries. Generating the set of recommended data item queries may further include submitting a third request to a second service to obtain a third subset of recommended data item queries, the third subset of recommended data item queries associated with a term included in the natural language input. The method may further include receiving an identifier of the client application, and the first service selects the first set of recommended data item queries based on the identifier of the client application.

Analyzing the natural language input to determine the sufficiency condition may include providing the natural language input as an input to a machine learning model that is trained on a dataset including respective natural language inputs associated with respective sufficiency determinations.

The predetermined query prompt text may be predetermined first query prompt text, and the method may further include, prior to generating the natural language query string for eliciting the answer to the data item query, ranking the identified group of data item queries for which answers were not included in the natural language input based on relevance of the data item queries to a subject of the natural language input. The ranking may include generating a relevance inquiry prompt including predetermined second query prompt text, text from the identified group of data item queries, and the natural language input, providing the relevance inquiry prompt to the generative output engine, and receiving, from the generative output engine, a ranking of the data item queries of the identified group of data item queries. The method may further include selecting, based on the ranking, at least one data item query from the identified group of data item queries as the data item query.

A computer-implemented method of generating questions in response to a user input may include receiving a natural language input from a graphical user interface of a client application operating on a client device, obtaining a group of recommended data item queries, the group of recommended data item queries including text extracted from at least one knowledge base document of a set of knowledge base documents, and ranking the group of recommended data item queries based on a relevance of the recommended data item queries to a subject of the natural language input. Ranking may include generating a first prompt including predetermined first query prompt text, text from the group of recommended data item queries, and the natural language input, providing the first prompt to a generative output engine, and receiving, from the generative output engine, a ranking of the recommended data item queries of the group of recommend data item queries. The method may further include selecting, based on the ranking, at least one data item query from the recommended data item queries, for the selected at least one data item query, generating a natural language query string for eliciting, from a user, an answer to the at least one data item query, including generating a question generation prompt including predetermined second query prompt text and the at least one data item query, providing the question generation prompt to the generative output engine, and receiving the natural language query string from the generative output engine, causing display of the natural language query string to the user, receiving, from the user, a response including the answer to the at least one data item query, and storing the answer to the at least one data item query in association with the natural language input.

Obtaining the group of recommended data item queries may include identifying a knowledge base document of the set of knowledge base documents, generating a data item query prompt including predetermined third query prompt text, text from the knowledge base document, and the natural language input, providing the data item query prompt to the generative output engine, and receiving, from the generative output engine, at least a subset of the group of recommend data item queries.

The method may further include, prior to ranking the group of recommended data item queries, removing, from the group of recommended data item queries, data item queries for which answers were included in the natural language input.

The method may further include, prior to ranking the group of recommended data item queries analyzing the group of recommended data item queries to identify redundant data item queries that are directed to eliciting same information, generating a representative data item query for the redundant data item queries, and including the representative data item query in the group of recommended data item queries. Generating the representative data item query for the redundant data item queries may include generating a representative data item query prompt including predetermined third query prompt text and text from the redundant data item queries, providing the representative data item query prompt to the generative output engine, and receiving the representative data item query from the generative output engine.

The graphical user interface may be a support request graphical user interface associated with the client application. The method may further include generating an issue record including the answer to the at least one data item query, and storing the issue record in association with an issue tracking system.

A system of a support platform may include one or more processing units and computer readable memory storing computer readable instructions that when executed by the one or more processing units cause the system to receive a natural language input, the natural language input provided to a support request graphical user interface of a client application operating on a client device, obtain a set of recommended data item queries, and analyze the set of recommended data item queries to identify a subset of data item queries for which answers were not included in the natural language input. The analyzing may include, for a recommended data item query of the set of recommended data item queries, generating a second prompt including predetermined query prompt text, the recommended data item query, and the natural language input, providing the second prompt to a generative output engine, receiving, from the generative output engine, a generative response, and analyzing the generative response to determine whether an answer to the recommended data item query was included in the natural language input. The computer-readable instructions may further cause the system to generate a composite data item query from at least a first data item query and a second data item query from the subset of data item queries, the composite data item query configured to elicit information for the first data item query and the second data item query, generate a natural language query string for eliciting an answer to the composite data item query, cause display of the natural language query string in the support request graphical user interface, receive a response including the answer to the composite data item query, and store the answer to the composite data item query in association with the natural language input.

Generating the natural language query string may include generating a question generation prompt including predetermined second query prompt text and the composite data item query, providing the question generation prompt to the generative output engine, and receiving the natural language query string from the generative output engine.

Obtaining the set of recommended data item queries may include receiving an identifier of the client application, and submitting a request to a service to obtain the set of recommended data item queries, the request including the identifier of the client application, and the service selects the set of recommended data item queries based on the identifier of the client application. Obtaining the set of recommended data item queries may further include submitting an additional request to an additional service to obtain additional recommended data item queries, the additional recommended data item queries associated with a term included in the natural language input.

The computer readable instructions may further cause the system to generate an issue record including the answer to the recommended data item query, and store the issue record in association with an issue tracking system.

The computer readable instructions further cause the system to, prior to analyzing the set of recommended data item queries to identify the subset of data item queries for which answers were not included in the natural language input, remove, from the set of recommended data item queries, recommended data item queries that may be not supported by a support request interaction type associated with the natural language input.

### BRIEF DESCRIPTION OF THE DRAWINGS

In the drawings:

FIG. 1 depicts an example system in which various features of the present disclosure may be implemented.

FIG. 2 depicts an example system in which a support service may interact with a generative output system for generating data item queries and natural language query strings.

FIG. 3A depicts an example operation for generating natural language query strings based on user inputs.

FIG. 3B depicts an example operation for generating data item queries based on user inputs.

FIGS. 4A-4E depict example graphical user interfaces for receiving user inputs and providing natural language query strings to elicit information related to the user inputs.

FIGS. 5A-5B depict additional example graphical user interfaces for receiving user inputs and providing natural language query strings to elicit information related to the user inputs.

FIGS. 6A-6E depict additional example graphical user interfaces for receiving user inputs and providing natural language query strings to elicit information related to the user inputs.

FIG. 7 depicts an example process for generating natural language query strings.

FIG. 8 depicts a system diagram and network/communication architectures that may support a system as described herein.

FIG. 9 depicts a functional system diagram of network/communication architectures that may support a system as described herein.

FIG. 10 depicts a simplified system diagram and data processing pipeline.

FIG. 11 depicts a system providing multiplatform prompt management as a service.

FIG. 12 shows a sample electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to analyzing natural language inputs provided by a user, as part of a support request, in order to automatically identify follow-up questions that would elicit additional information that is specifically relevant to solving or otherwise satisfying the user's support request. For example, many support interfaces (e.g., for technical support, business support, etc.) are provided via computer. A user may input a support request into a graphical user interface in order to initiate a support request and/or a support interaction (e.g., an interactive chat with an automated response engine and/or a human operator). The support request may include a natural language text input that describes the issue that the user is having or otherwise describes the subject for which the user is requesting support.

Since the support interface allows users to provide a natural language explanation of their needs, users may provide varying levels of detail or specificity in their explanations. In some cases, users may omit information that would be particularly useful to the resolution of the user's request. Accordingly, described herein are techniques for analyzing a natural language input provided by a user to identify additional information that would be relevant to satisfying the user's request, and generating natural language question prompts to present to the user to elicit the additional information.

In some cases, a support service may provide support for multiple different contexts. For example, a support service may provide support for multiple different software applications or platforms, corporate or employment services, and the like. In such cases, the support service may receive support requests directed to numerous different subject areas. Accordingly, identifying additional information that may be useful in the resolution of the support request is a nontrivial problem.

As described herein, a support service may analyze natural language inputs associated with support requests using multiple different techniques in order to identify a set of questions that will elicit highly relevant information from the user. The system prompts the user for answers to the questions, and then uses the received information to aid in the resolution of the support request (e.g., by providing a proposed solution to the user, or providing the additional information to a support agent). In some cases, analyzing the natural language inputs includes using a generative service to analyze knowledge base documents or other stored resources to identify the additional information. The particular knowledge base documents that are analyzed may be selected from among a larger set of knowledge base documents, based on the content of the natural language input, in order to improve the quality and relevance of the information that is being requested, as well as reduce processing requirements and response times.

The support service may also attempt to avoid asking the user for too much information, redundant information, or less relevant information. For example, for a given support request, the support service may identify a set of candidate data item queries (e.g., types of information, questions, facts, data, etc.) that are relevant to resolving the support request. The support service may then evaluate the candidate data item queries to remove any queries that would elicit redundant information, and to identify the candidate data item queries that are most relevant to resolving the support request. Thus, the user may be asked for only the most relevant information, which may improve the quality of the support results and generally improve the user experience. Information received from the user in response to the follow-up questions may be provided to a virtual support agent, a human support agent, and/or may be stored in association with an issue in an issue tracking system.

### Scalable Network Architecture for Automatic Content Generation

As described herein, the support service may use content generation tools for various aspects of the support service, including, without limitation, identifying data item queries, determining whether a user has already supplied pertinent information, determining or ranking the relevance of various data item queries, generating natural language query strings to elicit pertinent information from a user, and the like.

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes an input region that can receive support requests, questions, commands, references to content, links, and other input, at least a portion of which is provided as natural language text.

In some examples, the user may provide natural language inputs to a text input box or field of a support interface. The user-supplied natural language inputs may be used to formulate various prompts for a generative service, as described herein.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands—after the user types a slash character, any text input after the slash character can be considered as a command to instruct the underlying system to perform a task.

Regardless of how a software platform user interface is instrumented to receive user input, the user may provide an input that includes a string of text including a natural language input. The input may be used to generate various prompts, which may in turn be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; generate a prompt that includes a portion of the user's raw input in addition to metadata associated with the user's service request, insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated prompt can be provided as input to a secondary queue that meters and orders requests from one or more software platforms to a generative output system, such as described herein.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, the generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=‘https://example link/123456>projrct 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”: “Generate five words of placeholder text in the English language.”,
   “API_KEY: “hx-Y5u4zx3kaF67AzkXK1hC”,
   “user_token”: “PkcLe7Co2g-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”: “Hello world text goes here.”,
   “generation_time_ms”: 2
}

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, an input (e.g., a natural language input associated with a support request, a prompt, etc.) received from a user can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Prompts may also be generated by another service, engine, or operation of a support service or other software service described herein, and may include content from a user input. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports; metadata or other data or information associated with a software application from which a user input originated; and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”: “summarize the edits to this page made by my team since I last visited this page”,
   “modified_prompt”: “Generate a summary of each paragraph tagged with an editId attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”: “The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”: “Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url”.

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated With Generative Output Systems

In particular, embodiments described herein are focused on leveraging generative output engines to identify additional information to elicit from a user in a support context (and/or to produce content more generally) in a software platform used for collaboration between multiple users, such as documentation tools, issue tracking systems, project management systems, information technology service management systems, ticketing systems, repository systems, telecommunications systems, messaging systems, and the like, each of which may define different environments in which support may be requested or content may be generated by users of those systems. For example, a documentation system may provide a support interface in which users can input support requests that include natural language inputs, and a support service may use the natural language input to generate prompts for a generative output engine. As described herein, various services and software platforms may use or access a support service, and the support service may use generative output engines to service requests from various different platforms.

As another example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine (and/or a support service that uses a generative output engine), as described herein, in order to automatically generate natural language follow-up questions (in the context of a support service interaction), and/or generate structured or unstructured content within environments defined by those systems more generally. For example, a documentation system can leverage a generative output engine to, without limitation: identify additional information to request from a user in the context of a support interaction; determine whether salient information has already been supplied by a user in the context of a support interaction; determine the relative relevance of certain information to a resolution of a support request; generate natural language question prompts to elicit salient information from a user in the context of a support interaction; summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform-multitenant or otherwise-as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations'compliance with an organization's policies and organization-owned content access policies may be exacerbated as a provider's platform suite grows. For example, a provider that maintains three separate platforms may choose to provide three separate integrations interconnecting all three platforms. (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required of individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

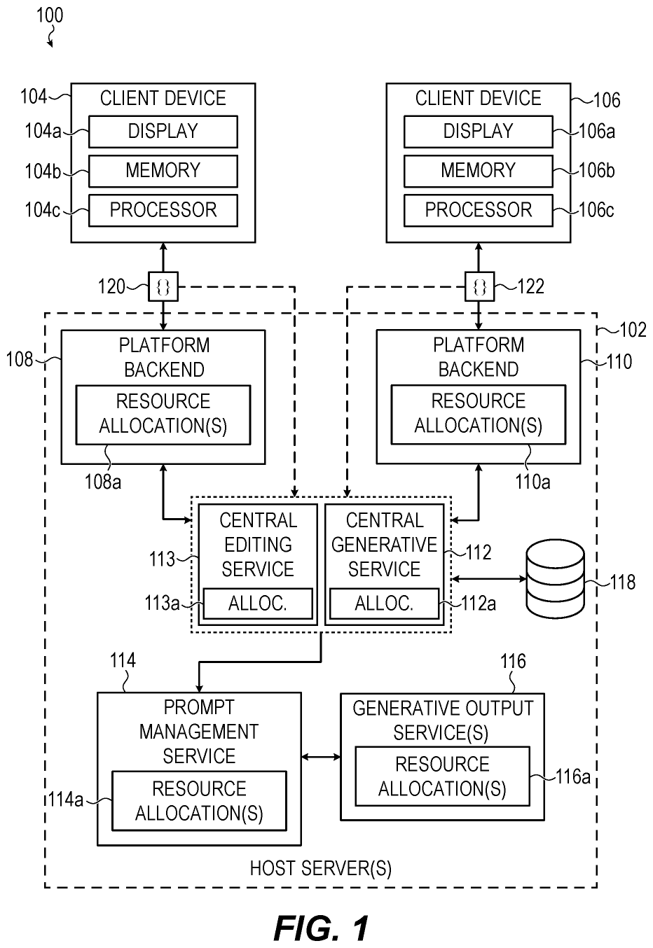

These foregoing and other embodiments are discussed below with reference to FIGS. 1-12. However, the detailed description given herein with respect to these figures is for explanation only and should not be construed as limiting.

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other example software platforms include support services, ITSM systems, chat platforms, messaging platforms, and the like. These backends can be communicably coupled to a generative output engine that can be leveraged to provide unique intelligent functionality to each respective backend. For example, the generative output engine can be configured to receive prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system, as well.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized generative service 112.

The centralized generative service 112 can be configured to cause rendering of a frame or panel within respective frontends of each of the first platform backend 108 and the second platform backend 110. In this manner, and as a result of this construction, each of the first platform and the second platform present a consistent user content editing experience for accessing generative services including the automated assistant services and other operations described herein.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generative service 112 that can be called by each respective frontend whenever it is required to present the user of that respective frontend with a generative interface that may facilitate a chat-based exchange with one or more automated assistant services.

The documentation platform's frontend may call upon the centralized generative service 112 to assist with content discovery and creation with respect to pages or documents managed by the documentation platform. Similarly, the issue tracking platform's frontend may call upon the centralized generative service 112 to perform content discovery, generation, and management of issues or tickets managed by the issue tracking platform.

Similarly, the software platforms may issue prompts to the centralized generative service 112 to support user interactions or services that are not direct user requests for generative outputs. For example, in the context of a support interaction, a software platform (e.g., a support service and/or a support service associated with a particular software platform) may utilize the centralized generative service 112 to identify particular items of information that would be relevant for resolving a support request, to generate natural language query strings to elicit such information, and the like.

The system 100 may also include a centralized content editing frame service 113, which can operate an editor or editing service for each of multiple platforms. More specifically, the centralized content editing frame service 113 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor. The centralized content editing frame service 113 can parse text input provided by users of the documentation platform frontend and/or the issue tracking platform backend, monitoring for command and control keywords, phrases, trigger characters, and so on. In many cases, for example, the centralized content editing frame service 113 can implement a slash command service that can be used by a user of either platform frontend to issue commands to the backend of the other system.

For example, the user of the documentation platform frontend can input a slash command to the content editing frame, rendered in the documentation platform frontend supported by the centralized content editing frame service 113, in order to type a prompt including an instruction to create a new issue or a set of new issues in the issue tracking platform. Similarly, the user of the issue tracking platform can leverage slash command syntax, enabled by the centralized content editing frame service 113, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; content editing elements can include and/or may be implemented to include many features, which may vary from embodiment to embodiment. For simplicity of description the embodiments that follow reference a centralized content editing frame service 113 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content editing frame service 113 can be extended to include additional features and functionality-such as a slash command and control feature-which, in turn, can automatically be leveraged by any further platform that incorporates a content editing frame, and/or otherwise integrates with the centralized content editing frame service 113 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

Similar functionality can also be provided by the centralized generative service 112. For example, as described herein the centralized generative service 112 may provide a chat-based interface in a panel or region of a frontend application. Through a series of natural language inputs, the system may provide content discovery, content modification, content generation, or content management operations. In some cases, the centralized generative service 112 utilizes a variety of software plugins and/or automated assistant services to provide the requested operations. The centralized generative service 112 may generate prompts, which, in this example, can be provided as input to a prompt engineering/prompt preconditioning service (such as the prompt management service 114) that, in turn, provides a modified user prompt as input to a generative output service 116.

The generative output service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on. Additional examples include recommended data item queries, filtered lists of data item queries, relevance scores or rankings of recommended data item queries, natural language query prompt text for eliciting responses to data item queries, and the like.

The centralized content editing frame service 113 and/or the centralized generative service 112 can be configured to provide suggested prompts to a user as the user types. For example, as a user begins typing a slash command in a frontend of some platform that has integrated with a centralized content editing frame service 113 as described herein, the centralized content editing frame service 113 can monitor the user's typing to provide one or more suggestions of prompts, commands, or controls (herein, simply “preconfigured prompts”) that may be useful to the particular user providing the text input. Similarly, the centralized generative service 112 may monitor the user's typing and provide one or more suggestions of prompts, commands, or controls. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content editing frame service 113 and/or the centralized generative service 112 can be configured to suggest one or more prompts that can be provided as input to a generative output engine as described herein to perform a useful task, such as summarizing content rendered within the centralized content editing frame service 113, reformatting content rendered within the centralized content editing frame service 113, inserting cross-links within the centralized content editing frame service 113, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system. Alternatively, when interacting with the same documentation system, a user having a role of “human resources professional” may be presented with prompts associated with manipulating or summarizing information presented in a directory system or a benefits system, instead of the issue tracking system or the code repository system. More generally, in some embodiments described herein, a centralized content editing frame service 113 and/or the centralized generative service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content editing frame service 113 and/or the centralized generative service 112, as described herein, can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content editing frame service 113 and features thereof (such as a slash command processor), between different software platforms in an authenticated and secure manner. For simplicity of description, the embodiments that follow reference a configuration in which a centralized content editing frame service is configured to implement a slash command feature-including slash command suggestions-but it may be appreciated that this is merely one example and other configurations and constructions are possible. Similarly, the centralized generative service 112 may be configured to implement a variety of commands initiated using a command character (e.g., a slash, @, or other special symbol), can be used to invoke various assistant services, plugins, or other operations from the generative interface.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content editing frame service 113 and the centralized generative service 112. Information can be transacted by and between the frontend, the first platform backend 108 and the centralized content editing frame service 113 and the centralized generative service 112 in any suitable manner, form, or format. In many embodiments, as noted above, the client device 104 and in particular the first platform frontend can be configured to send an authentication token 120 along with each request transmitted to any of the first platform backend 108 or the centralized content editing frame service 113, the centralized generative service 112, the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content editing frame service 113 and the centralized generative service 112. Information can be transacted by and between the frontend, the second platform backend 110 and the centralized content editing frame service 113 and the centralized generative service 112 in any suitable manner, form, or format. In many embodiments, as noted above, the client device 106 and in particular the second platform frontend can be configured to send an authentication token 122 along with each request transmitted to any of the second platform backend 110 or the centralized content editing frame service 113 and the centralized generative service 112.

As a result of these constructions, the centralized content editing frame service 113 and the centralized generative service 112 can provide uniform feature sets to users of either the client device 104 or the client device 106. For example, the centralized content editing frame service 113 can implement a slash command processor to receive prompt input and/or preconfigured prompt selection provided by a user of the client device 104 to the first platform and/or to receive input provided by a different user of the client device 106 to the second platform.

In some cases, the graphical user interfaces of the platform frontends may include a support request graphical user interface, which may be associated with a support service. The support request graphical user interface may be a component of a graphical user interface of a particular software platform, or a component of a graphical user interface of a support service that provides support services for multiple software platforms. Stated another way, a support request graphical user interface may be integrated into the graphical user interface of a software platform that the support service supports, and/or a support service may be instantiated as its own software platform (and which may provide support services for one or more software platforms or other subjects, contexts, or the like).

The centralized content editing frame service 113 and the centralized generative service 112 may ensure that common features are available to frontends of different platforms. One such class of features provided by the centralized content editing frame service 113 and the centralized generative service 112 invokes output of a generative output engine of a service such as the generative engine output service 116.

For example, as noted above, the generative output service 116 can be used to generate content, analyze content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content editing frame service 113 and the centralized generative service 112, or to receive prompts or other input from services and/or software platforms, such as support services. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, perform searches of databases (such as user graphs, team graphs, and so on) of either the first platform backend 108 or the second platform backend 110, change grammar or spelling of the user input, change a language of the user input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible). In instances where a service or software platform (e.g., a support service) generates prompts for the generative output service 116, the prompt management service 114 may be bypassed, and the service or software platform may structure its prompts as an API request to the generative output surface 116. In other examples, prompts or prompt requests from a service or software platform are provided to the prompt management service 114 for processing to produce the modified or preconditioned prompt for the generative output service 116.

In response to receiving a prompt (e.g., a modified prompt and/or a properly formatted prompt directly from a service or software platform) as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114 or the service or software platform that issued the prompt. In other cases, output of the generative output service 116 can be provided to the centralized content editing frame service 113 or the centralized generative service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized content editing frame service 113, the centralized generative service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device. The templatized prompts or the static portions thereof may be referred to as predetermined query prompt text or predetermined prompt text.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user 123 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. Many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on). The centralized content editing frame service 113 is supported by a processor and memory and network connection (and/or database connections) collectively represented for simplicity as the resource allocations 113a. The centralized generative service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect keywords or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized content editing frame service 113 or a centralized generative service 112.

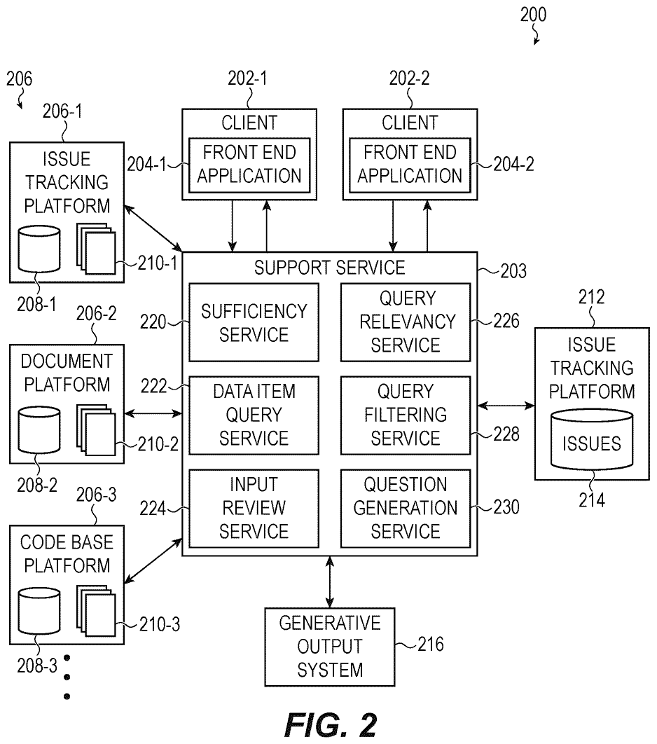

FIG. 2 depicts an example system 200 in which a support service 203 may provide support services for software platforms or any other subject. More particularly, the support service 203 may facilitate support interactions between users and the support service 203. The support service 203 may provide automated support operations, including automated chat services, as well as agent-supported services. As described herein, the support service 203 may receive support requests from a user, and evaluate the support requests (including any natural language inputs provided with the support requests) to identify information that may be particularly relevant to resolving the support request. The support service 203 may then determine whether that information was already provided, and if not (and if the information satisfies other conditions and relevance thresholds), issue a natural language query string to elicit the information from the user.

The system 200 includes clients 202 (202-1, 202-2). The clients can be implemented as any suitable electronic device. In many embodiments, the client devices 202 are personal computing devices such as desktop computers, laptop computers, or mobile phones. The clients 202 execute respective frontend applications 204 (204-1, 204-2). The frontend applications 204 may be frontend applications of the support service 203. For example, the frontend applications may instantiate graphical user interfaces with which users may interact with the support service 203. For example, the frontend applications 204 may facilitate functions such as receiving support requests (including natural language inputs), providing chat functionality with the support service 203 (automated chat services or human agents), providing access to support request and resolution information, and the like. In some cases, the frontend applications 204 are frontend applications of other software platforms, such as an issue tracking platform 206-1, document platform 206-2, codebase platform 206-3 (or any other software platform described herein), and the frontend applications 204 instantiate a graphical user interface for accessing the support service 203. Where the support service graphical user interface is part of a graphical user interface of another application or software platform, the support service graphical user interface may provide access to support for only that application or software platform only. In other examples, the support service graphical user interface may provide access to support services for any software platform, application, service, or other subject that the support service 203 supports.

In some cases, the support service 203 is a centralized support service 203 that provides support services for multiple software platforms 206. For example, each software platform 206 may be configured to interface with the support service 203 in order to access the functionality provided by the support service 203. As described herein, the support service 203 may be configured to provide tailored support services to each software platform 206. Stated another way, the support service 203 may be configured as a platform-independent support engine that can provide tailored support services for different software platforms by accessing information that is unique to those software platforms. Thus, for example, when the support service 203 receives support requests via (or that specifically reference) a particular software platform, the support service 203 may perform functions with reference to data associated with that application.

In particular, as shown in FIG. 2, each software platform may be associated with a data store 208 and a knowledge base 210. The data stores 208 may store data associated with the software platform. For example, the data store 208-1 may store issue records of the issue tracking system 206-1, the data store 208-2 may store documents associated with the document platform 206-2, and the data store 208-3 may store source code of the codebase platform 206-3. It will be understood that these are merely examples, and that the data stores 208 may store any data used by or otherwise associated with the respective platforms. The knowledge bases 210 may store knowledge base documents associated with the respective platforms 206. Knowledge base documents may be generated by agents, administrators, or other users of the software platforms 206, and may include information that aids in the resolution of issues or otherwise relates to the platforms 206. For example, knowledge base documents may include descriptions of known support topics, as well as workflows, procedures, references, or other information that can be used to resolve those support topics. Users of the platforms 206 (and/or support agents) may search for and access the knowledge base documents. While each software platform 206 may include or be associated with a data store and knowledge base, when providing support functionality to a software platform, the support service 203 may access the data store and knowledge base of that software platform. In some cases, the support service 203 may constrain its operations to the data store and knowledge base of a particular software platform, while in other cases, the support service 203 may access data stores and knowledge bases of other software platforms (e.g., where an organization uses multiple software platforms that are interlinked or otherwise serviced by the same support service).

As shown in FIG. 2, the support service 203 may provide support services for various software platforms, including an issue tracking platform 206-1. For example, users of the issue tracking platform 206-1 may access the support service 203 to obtain help with the operation of the issue tracking platform 206-1. In some cases, the support service 203 may also interact with an issue tracking platform 212 to generate and/or populate issue records. For example, when a user contacts the support service 203 (as a standalone support platform or as part of a software platform 206), the support service 203 may generate (or modify, update, supplement, etc.) an issue record in the issue tracking platform 212. The issue tracking platform 212 may include a data store 214 that stores the issues generated by the support service 203. In some cases, the support service 203 may be understood as a component or service of the issue tracking platform 212. For example, the support service 203 may provide generative content services to the issue tracking platform 212, such as to supplement a support chat interface or service provided by the support service 203.

The issue tracking platforms 212, 206-1 may in some cases be the same issue tracking platform. For example, the support service 203 may support users of the issue tracking platform, while also using the functionality of the issue tracking platform to service the support requests from its users. In other examples, the issue tracking platforms 212, 206-1 may be separate instances of the same software platform, or different software platforms entirely.

As described herein, the support service 203 may use a generative output system 216 to implement various operations and functionalities of the support service 203. For example, as described herein, the generative output system 216 may be used for identifying data item queries, determining whether a user has already supplied pertinent information, determining or ranking the relevance of various data item queries, generating natural language query strings to elicit pertinent information from a user, and the like. The generative output system 216 may correspond to the generative output service 116, the central generative service 112, and/or other combinations of the generative output service 116 and other services that support the functionality of the generative output service 116.

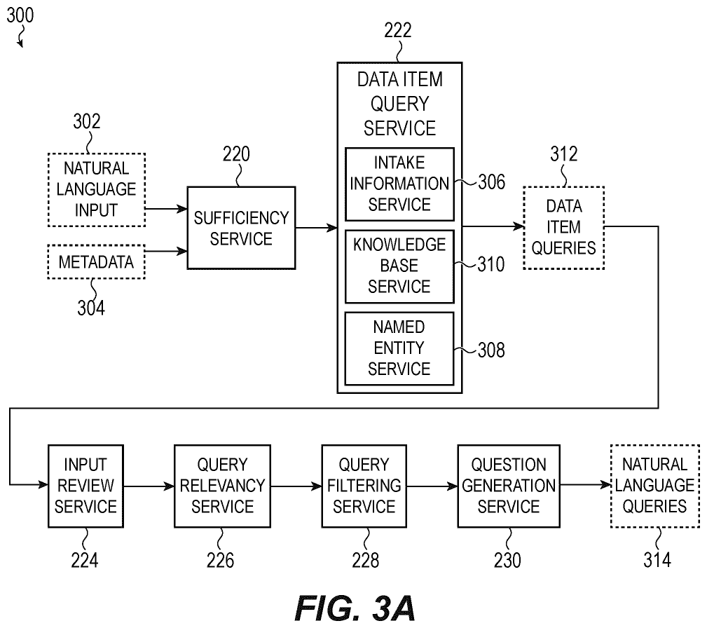

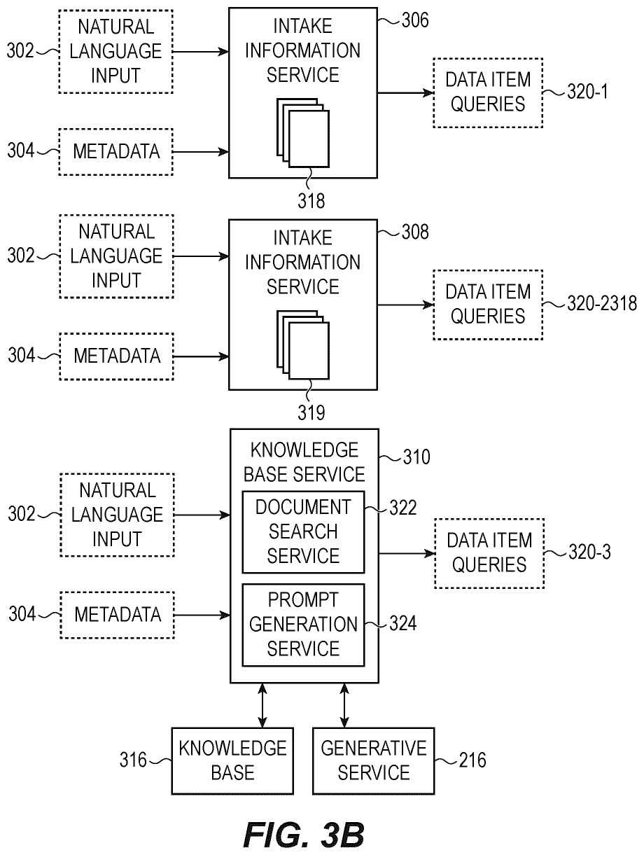

The support service 203 may include various services that provide the functionality of the support service 203. For example, the support service 203 may include a sufficiency service 220, data item query service 222, an input review service 224, a query relevancy service 226, a query filtering service 228, and a question generation service 230. The support service 203 may use these services in order to identify and elicit additional salient information from a user based on a natural language input from the user associated with a support request. The functions of these services are described in greater detail with respect to FIG. 3A.

FIG. 3A illustrates an example operation 300 of the support service 203. The operation 300 may be initiated in response to a support request initiated by a user (which may include a natural language input provided by the user in a graphical user interface), and may generate one or more natural language query strings that are specifically tailored to elicit additional information, from the user, that is relevant to resolving the support request.

For example, with reference to FIG. 3A, a natural language input 302 may be received from a graphical user interface of a client application operating on a client device. The natural language input may be input by a user into a text field of the graphical user interface. In some cases, the natural language input may correspond to a plain-language description or summary of a question, issue, concern, or other support request. For example, a graphical user interface associated with a support service may prompt a user to provide a description or summary of the support request.

In some cases, metadata 304 may also be received in association with the natural language input 302. The metadata 304 may include information about a software platform that is associated with the support request. For example, if the support request is initiated from a document platform, the metadata 304 may include an identifier of the document platform, as well as other information such as a version of the document platform, an identifier of the user's context when the support request was initiated, an age of a user session with the document platform, an identifier of a tenant of the document platform, or the like. It will be understood that the particular contents of the metadata 304 may differ based on various factors, such as the platform in which the support request was initiated, whether the support service is a dedicated service or a shared service, or the like. As used herein, the natural language input 302 and the metadata 304 may collectively be referred to as an input or a user input.

The natural language input 302 and optionally the metadata 304 may be received by the sufficiency service 220 of the support service 203. The sufficiency service 220 may include support-request analysis engine that analyzes the natural language input 302 to determine whether a sufficiency condition is satisfied, where the sufficiency condition indicates whether a follow-up question is warranted. In particular, there are instances where it may not be useful or necessary to ask a user follow-up questions before proceeding with a support request. For example, a natural language input (or the support request more generally) may include all of the information necessary to resolve the user's support request, or it may relate to a support request for which no additional information is necessary, or it may relate to a support request that requires information that the user would not have access to. In such cases, it may be unnecessary and potentially detrimental to prompt the user with further question prompts related to the support request. Accordingly, the sufficiency service 220 determines whether a sufficiency condition of the natural language input is satisfied. If the sufficiency service 220 determines that the sufficiency condition is satisfied (e.g., no follow-up questions are necessary or warranted), then the support service 203 may omit further operations related to generating follow-up questions, and instead proceed to a next phase of the support request process. For example, the support service 203 may proceed to operations such as creating an issue record (including the natural language input 302, the metadata 304, and optionally other information) or providing the natural language input 302 and other optional information to a support agent who may continue to assist the user. If the sufficiency service 220 determines that the sufficiency condition is not satisfied (e.g., follow-up questions are warranted), then the support service may continue with operations to identify information to be elicited and generate suitable questions to elicit the information.

The sufficiency service 220 may include a support-request analysis engine that uses one or more machine learning models that are trained on a dataset including respective natural language inputs associated with respective sufficiency determinations. For example, the dataset may include a large number of sample natural language inputs that have been entered by users as part of support requests, each input tagged with information indicating whether follow-up question are warranted for that input. The tags may be applied in various ways, including manually (e.g., by human reviewers reading the natural language inputs and making a determination of whether follow-up questions are warranted), or by reference to historical or sample support request data. For example, the training dataset may include natural language inputs from a plurality of previously occurring support requests, each input tagged with information identifying whether or not a support agent asked follow-up questions in response to the user's input. Thusly trained, the machine learning model may accept inputs as described above (e.g., natural language inputs 302), and provide, as output, a sufficiency determination (e.g., whether the sufficiency condition is satisfied), or information from which the sufficiency determination can be made.

In accordance with a determination that the sufficiency condition is not satisfied (e.g., follow-up questions are warranted based on the natural language input), the support service 203 may perform operations to identify data item queries from the natural language input. As used herein, a data item query may correspond to information that is to be elicited from the user. Data item queries are determined based on the semantic content of the natural language input, and represent information that is determined to be relevant or salient to the resolution of the request represented in the natural language input. For example, for a natural language input that includes “my email application isn't sending messages,” a data item query of “email application name” may be generated or identified, reflecting that the name of the email application may be particularly relevant for a support agent or other support service to resolve the request. As another example, for a natural language input of “I can't assign issues to my team,” a data item query of “team identifier” may be generated or identified, reflecting that the team identifier may be particularly relevant for a support agent or other support service to resolve the request. As described herein, data item queries generally represent a type of information or a particular item of information having relevance to the resolution of the issue, and may serve the basis for natural language queries that are ultimately provided to a user in order to elicit the information indicated by the data item query. Data item queries may be referred to herein as query items.

As shown in FIG. 3A, the support service 203 may include data item query service 222. The data item query service 222 may include an intake information service 306, a knowledge base service 310, and a named entity service 308. The data item query service 222 may each use the natural language input and optional metadata to generate data item queries 312, from which natural language queries may ultimately be generated.

FIG. 3B illustrates further details of the intake information service 306, knowledge base service 310, and named entity service 308. The intake information service 306 may be configured to accept, as input, the natural language input 302 and the metadata 304. The intake information service 306 may be configured to identify data item queries relating to intake information for a support or other request. Intake information may generally correspond to a set of information items that may be relevant to any support request relating to a particular subject. In some cases, the intake information service 306 may determine, based at least in part on the metadata 304 (and/or the natural language input 302) a subject of the support request. In some cases, the subject may relate to a particular software product, platform, or client application from which the support request originated and/or to which the support request relates. In some cases, an identifier of the subject is included in the metadata, such as when the natural language input was provided in a graphical user interface of a particular software product, platform, or application.

The intake information service 306 may select an intake data item query set from a set of candidate intake data item query sets 318 based on the identified subject of the support request (and/or an identifier of a client application, software product or platform, or other information included in the natural language input 302 and/or metadata 304). The intake data item query sets 318 may each include one or more data item queries that are relevant to the subject of the support request. In some cases, different intake data item query sets are provided for different client applications (e.g., from which the support request originated or to which it refers), different support subjects or topics, or the like. The intake information service 306 may select an intake data item query set based on the information contained in the natural language input or metadata (e.g., an identifier of a client application, software product or platform, or the like).

The intake data item queries may be general or generic information that may be useful for support requests relating to a subject, and may not be tailored to resolving an actual issue described in the support request. As one specific example, an intake data item query set for a document platform may include data item queries such as “when did the issue start; what teams are impacted; what workspace is impacted; what document is impacted,” or the like. Different intake data item query sets may be provided for different subjects, software platforms, etc. Based on the selected set of intake data item queries, the intake information service 306 may output a set of recommend data item queries 320-1. The recommended data item queries from the various services of the data item query service 222 may be further processed to ultimately generate follow-up queries to present to a user, as described herein.

The data item query service 222 may also include a named entity service 308. The named entity service 308 may be configured to accept, as input, the natural language input 302 and the metadata 304. The named entity service 308 may be configured to identify data item queries relating to one or more named entities in the natural language input 302. Named entity data item queries may generally correspond to a set of information items that may be relevant to any support request that includes an explicit reference to a known, named entity, such as a project, an issue, a workspace, etc. As a particular example, a support request may include a reference to an “issue,” which may refer to a particular type of data structure in an issue tracking platform (e.g., an issue record). In response to identifying the term “issue” in the support request, the named entity service 308 may select one or more data item queries that are relevant to support requests relating to issue records (e.g., issue title, issue identifier, issue status, identifier of project that contains the issue, etc.). As another example, a support request may include a reference to a “template,” which may cause the named entity service 308 to select data item queries relating to templates (e.g., template identifier, template category, document editing permissions, etc.).

The named entity service 308 may include various sets of named entity data item queries 319 for different named entities. Thus, the named entity service 308 may identify one or more named entities in a natural language input, select the appropriate set(s) of data item queries for the named entities, and output the selected set as recommend data item queries 320-2.

The data item query service 222 may also include a knowledge base service 310. The knowledge base service 310 is configured to generate data item queries based on content in knowledge base documents. In particular, knowledge base documents may be generated by agents, administrators, or other users (or automatically, such as by a generative service), and may include information that aids in the resolution of support requests, issues, or otherwise include information that relates to the potential subjects of support requests. For example, knowledge base documents may include descriptions of known support topics, as well as workflows, procedures, references, or other information that can be used to resolve support requests. The knowledge base service 310 may generate data item queries based on the contents of the knowledge base documents, as described herein.

The knowledge base service 310 may include a document search service 322 and a prompt generation service 324. The knowledge base service 310 may be operatively coupled with or otherwise capable of communicating with a knowledge base 316 and the generative output system 216. The knowledge base 316 may include knowledge base documents that the knowledge base service 310 uses to generate data item queries. The knowledge base 316 may include or encompass knowledge bases for multiple different software platforms, applications, programs, or any other subject areas. The knowledge base service 310 may use the generative output system 216 to perform various operations, including identifying, in knowledge base documents, potential data item queries.

In response to receiving a request for recommended data item queries, the knowledge base service 310 (e.g., the document search service 322) may identify one or more knowledge base documents, from the knowledge base 316, based on the user input (e.g., the natural language input 302 and/or the metadata 304). In some cases, identifying the knowledge base document includes identifying a set of knowledge base documents that relate to a particular named entity in the input, or that relate to a software platform identified or mentioned in the input, or are otherwise relevant to the natural language input. In some cases, identifying the knowledge base document includes identifying knowledge base documents that are associated with the client application in which the user provided the natural language input and/or initiated a support request.

Since the knowledge base documents are used as a source of potential data item queries, identifying a set of knowledge base documents that relate to the support request provides a manageable number of potential sources of information from which to generate data item queries. For example, without first searching for relevant knowledge base documents, the knowledge base service 310 would need to search through all available knowledge base documents for potential data item queries, which would increase processing requirements and response times, and generally be inefficient. Accordingly, the knowledge base service 310 first identifies relevant knowledge base documents, and then uses text from the knowledge base documents to identify recommended data item queries from that limited set of relevant documents. In some cases, knowledge base documents may include links to other knowledge base documents or other sources. In such cases, the knowledge base service 310 may traverse the links to identify other potential knowledge base document sources for data item queries.

The knowledge base service 310 may then generate a data item query prompt comprising predetermined query prompt text, text from the identified knowledge base document(s), and the natural language input 302. The data item query prompt may be a request to a generative service to identify, in the identified text from the knowledge base document(s), data item queries that are relevant to the natural language input. As described herein, the generative service may use various models, including large language models, to identify, in the text of the provided knowledge base document(s), data item queries that are relevant to the natural language input (e.g., that may be relevant to resolving a support request identified in the natural language input). Since the knowledge base documents contain information that is specifically generated to provide information about issues, troubleshooting operations, and resolutions to support requests or other issues, the data item queries that are generated based on and/or from the knowledge base may be particularly relevant for resolving support requests.

Once a data item query prompt is created, the knowledge base service 310 may provide the data item query prompt to a generative output engine (e.g., the generative output system 216), and receive, from the generative output engine, a set of recommend data item queries 320-3. The recommended data item queries 320-3 may include text extracted from at least one knowledge base document of the set of identified knowledge base documents from the document search service 322.

In some cases, the knowledge base service 310 may, preemptively analyze knowledge base documents to identify data item queries that are suggested by the contents of the knowledge base document. For example, the knowledge base service 310 may use a generative service to analyze the text of the knowledge base documents and return a set of data item queries. The data item queries may be stored in association with the knowledge base document and/or an identifier of the knowledge base document. Thus, if the knowledge base service 310 identifies that the previously-analyzed knowledge base document may be relevant to a natural language input (e.g., with the document search service 322), the knowledge base service 310 may retrieve and/or select data item queries from the previously generated data item queries of that knowledge base document.

Returning to FIG. 3A, as described above, the natural language input 302 and the metadata 304 may be provided as input to the data item query service 222, which may submit a first request to a first service (e.g., the intake information service 306) to obtain a first set of recommended data item queries, submit a second request to a second service (e.g., the named entity service 308) to obtain a second set of recommended data item queries, and submit a third request to a third service (e.g., the knowledge base service 310) to obtain a third set of recommended data item queries. The data item query service 222 may provide recommended data item queries 312 (which may be all or a subset of the recommended data item queries 320 from each of its various services) as output for further operations.

The data item query service 222 identifies data item queries, or types of information, that may be useful for resolving the user's support request, but it may not determine whether the user has already provided such information. For example, a user may submit a natural language input that states “my email has not been working since this morning.” The data item query service 222 may generate a data item query for this input for the date that the issue began. However, since this information was already provided in the natural language input, it would not be helpful to ask the user a follow-up question to ascertain when the issue started. Accordingly, the recommended data item queries 312 and the natural language input 302 may be provided to an input review service 224. (While FIG. 3A illustrates the natural language input 302 and metadata 304 being provided as input to the sufficiency service, it will be understood that they may be provided to and/or used by any and/or all of the services, modules, or other components of the support service 203.) The input review service 224 analyzes the recommended data item queries 312 and the natural language input 302 and determines whether the natural language input 302 already includes information that is responsive to the recommended data item queries 312. The input review service 224 ultimately identifies a subset of data item queries for which answers were not already included in the natural language input 302.

The input review service 224 may use a generative service (e.g., the generative output system 216) to select data item queries, from the set of recommended data item queries 312, data item queries that were not already answered in the natural language input 302. For example, the input review service 224 may generate a prompt comprising predetermined query prompt text, one or more recommended data item queries 312, and the natural language input, and may provide the prompt to the generative service. The predetermined query prompt text may request the generative service to identify whether information or answers that are responsive to the one or more recommended data item queries 312 are already provided in the natural language input. In some cases, the prompt may also request that the generative service provide the responsive information or answers in association with respective data item queries. The support service 203 may store this information and optionally provide the information and/or answers to a support agent, or populate an issue record with the information and/or answers.

The input review service 224 may receive a generative response, from the generative output engine, to its prompt, and may analyze the generative response to determine whether answers to the recommended data item queries were included in the natural language input. The input review service 224 may then generate a set of data item queries for which responsive answers and/or information were not provided in the natural language input, and provide that set of data item queries to the query relevancy service 226.

The query relevancy service 226 may be configured to rank the information to be elicited by the recommended data item queries (e.g., the data item queries that have not already been answered in the natural language input) based on its relevancy for resolving the support request. More particularly, depending on the particular support request, some data item queries may pertain to information that is more salient, relevant, or useful to resolving the support request than other data item queries. Since it may not be feasible or preferable to ask a user to provide responses to every data item query that was identified, the support service 203, using the query relevancy service 226, may rank the data item queries for relevancy to the support request so that the most relevant information can be elicited. As a specific example, for a support request of “I can't assign an issue to a team member,” the support service 203 may identify data item queries for an identifier of the issue to be assigned, and a date on which the error occurred. In this case, the identifier of the issue may be more relevant or useful for resolving the request than the data on which the error occurred. Thus, ranking the data item queries with the query relevancy service 226 allows the support service 203 to preferentially ask the user follow-up questions based on the relevance of the information to the subject and/or the actual solution of the request in the natural language input.

The query relevancy service 226 may rank the data item queries at least in part using a generative service (e.g., the generative output system 216). For example, the query relevancy service 226 may generate a relevance inquiry prompt comprising predetermined query prompt text, text from the set of recommended data item queries (e.g., received from the input review service 224), and the natural language input 302. The predetermine query prompt text may request the generative service to provide a ranking of the data item queries based on the relevancy of the data item queries (and/or the information that is to be elicited by the data item queries). The query relevancy service 226 may provide the relevance inquiry prompt to the generative service, and receive, from the generative service, a ranking of the data item queries. The query relevancy service 226 may also determine and return relevancy scores or values for the analyzed data item queries, which may also be used to select which data item queries are ultimately used to generate follow-up questions, as described herein.

The support service 203 may select a subset of the ranked data item queries based on the relevancy ranking. For example, the support service 203 may select n of the highest ranking data item queries. The support service 203 may select a predetermined number of the highest ranking data item queries (e.g., the top one, two, three, four, or five, or another suitable number) of data item queries for further analysis and/or processing. In some cases, the support service 203 applies a relevancy condition, such that data item queries having a relevancy score that fails to satisfy the relevancy condition (e.g., below a threshold relevancy score) are not used. Thus, it is possible that no data item queries satisfy the relevancy condition, resulting in the support service 203 not generating any follow-up questions to the support request.

The query filtering service 228 receives a set of recommended data item queries that relate to information that has not already been provided, and that satisfy a relevancy condition. The query filtering service 228 provides additional filtering and conditioning functionality in order to select the final set of data item queries that will ultimately be used to generate natural language follow-up questions. For example, the query filtering service 228 may determine whether any of the data item queries relate to the same information or are likely to elicit the same information. For example, a data item query related to “when did the issue start” and “when did you first notice the error” may relate to the same underlying information. Moreover, asking a user both questions would be redundant and potentially confusing. Accordingly, the query filtering service 228 may be configured to rationalize the data item queries to generate a set of non-redundant data item queries to form the basis of the follow-up questions. The query filtering service 228 may perform several potential functions or operations on the data item queries. For example, the query filtering service 228 may remove or omit data item queries that relate to the same, redundant, or overlapping information (e.g., data item queries that would elicit the same information from the user). In such cases, the query filtering service may select one data item query of a set of redundant data item queries. As another example, the query filtering service 228 may combine data item queries (e.g., queries directed to the same, redundant, or overlapping information) to generate a composite data item query. Furthering the above example, a composite data item query may be “when did the issue start or when was it first noticed.”

The query filtering service 228 may perform these (or other) functions using a generative service. For example, the query filtering service 228 may generate one or more filtering prompts comprising predetermined query prompt text, text from the set of data item queries (e.g., received from the query relevancy service 226), and optionally the natural language input 302. The predetermined query prompt text may request the generative service to provide various filtering operations, such as those described above. For example, the prompt may request that the generative service combine all data item queries that relate to or would elicit the same information, or identify the data item queries that relate to or would elicit the same information (for the query filtering service 228 to further process to select a single representative data item query), or return only a single representative data item query for each set of data item queries that relate to or would elicit the same information.

As an additional example, the prompt may request that the generative service generate compound data item queries from groups of data item queries that are directed to related information. For example, for a support request relating to an issue in a document of a document platform, one data item query may request the “space,” another the “document,” and another the “section” to which the support request relates. Thus, a prompt requesting compound data item queries may result in the generative service returning a data item query for “the space, document, and section” to which the support request relates. Other filtering and/or blending operations may also be performed by the query filtering service 228.

The query filtering service 228 may output a set of data item queries from which follow-up questions are generated. The set of filtered data item queries may then be provided to the question generation service 230. The question generation service 230 is configured to generate natural language query strings, for the selected data item queries, to be presented to the user (e.g., in the graphical user interface of the client application in which the support request was provided) to elicit answers to the data item queries.

The question generation service 230 may use a generative service (e.g., the generative output system 216) to generate the natural language query strings. For example, the question generation service 230 may generate a question generation prompt that includes predetermined query prompt text and one or more data item queries. The predetermined query prompt text may request the generative service to formulate natural language query strings, for submission to a user, to elicit the information identified in or by the data item queries. In some cases, the predetermined query prompt text may include the natural language input and/or other interactions with the user (e.g., chat or message transcripts, or the like), which may provide additional context for the generative service to generate conversational and contextually relevant natural language query strings.

The question generation service 230 may provide the question generation prompt to the generative service (e.g., the generative output system 216) and may receive natural language query strings 314 from the generative service for each requested data item query. In some cases, multiple data item queries may be combined in a single prompt to the generative service, resulting in multiple natural language query strings, while in other cases, discrete prompts are provided for each discrete data item query.

Once the support service 203 receives the natural language query strings 314 from the generative service, the support service 203 may cause the natural language query strings 314 to be provided to a user. For example, the natural language query strings may be provided to a user in the same graphical user interface of the client application in which the support request was received. In other cases, the natural language query strings are provided in a different graphical user interface and/or via a different communication channel, such as in an email, chat message, telephone call or voicemail, or the like.

The support service 203 may receive, from the user, a response including the answer to the data item queries that underlie the natural language query strings. For example, the user may reply to the natural language query string in the same or different interface in which they were presented (e.g., in a response email, chat window, etc.).

The response may be processed in various ways. In some cases, the raw response may be used as-is (e.g., stored in an issue record or otherwise stored in association with the support request and/or the natural language input of the support request). In some cases, instead of or in addition to storing the raw response, the response may be analyzed, parsed, or otherwise processed to identify and/or isolate the information that is responsive to the underlying data item query. For example, a user response to a natural language query string of “please let me know when you first noticed the error” may include the text “it first happened on July 2.” The support service 203 may process this response and identify the date of “July 2” as the information that is responsive to the underlying data item query. The support service 203 may then store or otherwise associate the date “July 2” with the support request (and/or an issue record that is associated with the support request).

Once a user provides a response to the natural language query strings, the support service 203 may perform one or more actions, depending on various factors. For example, the support service 203 may generate an issue record including the answer to the natural language query string, and store the issue record in association with an issue tracking system (e.g., the issue tracking platform 212, FIG. 2). An issue record may generally refer to a data record, data structure, or other identifiable set of data that pertains to a support topic, and a support topic may refer to the particular problem or question for which support was sought. As one specific example, a support topic may correspond to a user encountering a problem creating a document in a software system. An issue record may be generated for the support topic, where the issue record includes information about the support topic, the status of the issue, communications between the user and the agent, a description of how the issue was resolved, and the like.

As another example, the support service 203 may store the user's answer in conjunction with the natural language input (and/or other information associated with the support request) without generating an issue record. In either case, the stored answer (along with other information) may be provided to a support agent or to another service of the support service 203. For example, the process described above for eliciting additional information from a user may be performed as part of an initial intake process for a support request, and once the follow-up questions (if needed) are answered, the information associated with the support request may be provided to a support agent, who may then work with the user to resolve the support request. In some cases, the information associated with the support request is provided to an automated or computer-based support agent (also referred to as an AI agent or AI support agent), which may use one or more generative services to engage with the user to resolve the support request.

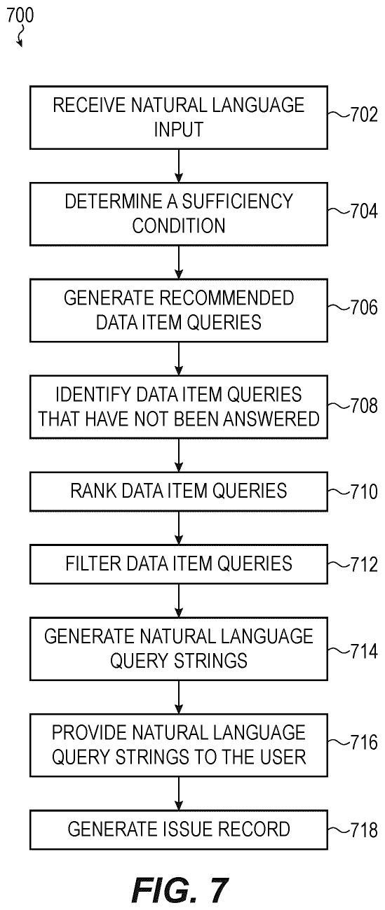

The operations described with respect to FIGS. 3A-3B may be performed one or multiple times for a support request and/or interaction with a user. For example, a user may provide multiple natural language inputs as part of a support request or during a support request interaction. The support service 203 may use the above described operations to analyze these natural language inputs and identify (and generate) follow-up questions to ask the user based on the natural language inputs. Further, as described herein with respect to FIGS. 7A-7B, for example, natural language inputs may be analyzed in real-time to identify follow-up questions and/or determine whether the user has provided answers to questions in the natural language input or a revised natural language input.

Further, as noted above, the support service 203 may in some cases facilitate human-based and AI-based support operations. However, in some cases, AI support agents and human support agents may have different capabilities. For example, in some cases, human support agents are authorized to access more or different information than an AI support agent. Accordingly, the support service 203 may be configured to identify, generate, and/or select different data item queries depending on the support request interaction type (e.g., whether the support interaction is associated with an AI agent or a human agent). For example, a data item query may correspond to a project name or an identifier of a particular issue record in an issue tracking system. However, in some cases, an AI agent may not be permitted (or may not have the capabilities) to access a project or an issue record. Accordingly, the support service 203 may be configured to filter out data item queries based on the support request interaction type. For example, the query filtering service 228 may be configured to remove, from a list of candidate data item queries, data item queries that are not supported by the support request interaction type associated with the current support request.

As described herein, the support request interaction type may change during the course of a support interaction. For example, the support service 203 may initially implement an AI agent to attempt to resolve a support request. If the support request is not resolved (or if the user requests a human agent or in response to other events), the support service 203 may transition to a human agent. As a specific example, in response to a natural language input, the support service 203 may generate follow-up questions that are limited based on the capabilities of an AI agent. However, once the support service 203 determines that the support request will be transitioned to a human agent, the support service 203 may re-evaluate the natural language input based on the new support request interaction type and ask any additional follow-up questions that were omitted from the initial interaction, but which are within the human agent's capabilities and would be relevant or useful to resolving the request.

FIGS. 3A-3B describe one example set of operations and process flow for generating natural language query strings for eliciting information to answer data item queries identified from a natural language input. However, it will be understood that the various services and operations of the support service 203 may be implemented in different orders and/or different combinations. For example, in some cases, data item queries may be filtered (e.g., by the query filtering service 228) prior to determining the relevancy of the data item queries (e.g., by the query relevancy service 226). As another example, the data item query services 222 may implement a subset of its services, such as omitting the knowledge base service 310 (e.g., where a support request is for a service that does not have an associated knowledge base). Moreover, functionality ascribed to separate services may be combined or provided by a single service, and functionality ascribed to a single service may be provided by multiple services. As one example, query filtering and relevancy rankings may be performed by a single service and/or using a single prompt to a generative service. In some cases, some services and/or their functionality are omitted entirely. For example, the query relevancy service may be omitted or not used in some implementations or instantiations.

Additionally, in some cases, the support service 203 may process different sets of candidate data item queries from the data item query service 222 separately or in parallel. For example, the data item queries from the intake information service 306 may be processed (e.g., by the input review service 224 and query relevancy service 226) separately from the data item queries from the knowledge base service 310 and from the named entity service 308. In such cases, the support service 203 may generate multiple (e.g., three) sets of candidate data item queries. These sets may then be combined and processed by the query filtering service 228 to identify a subset of data item queries to use as the basis for follow-up questions.

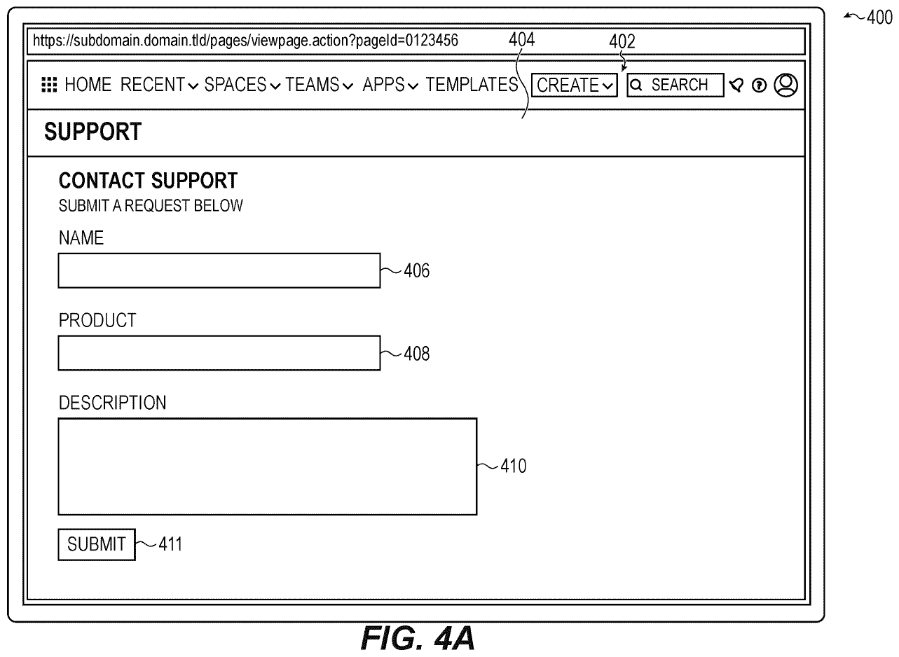

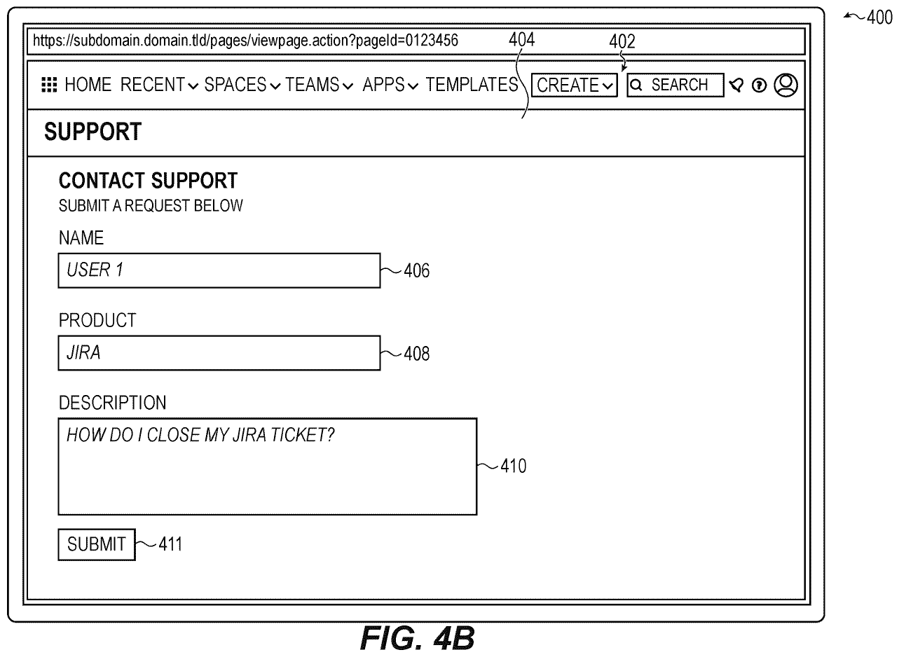

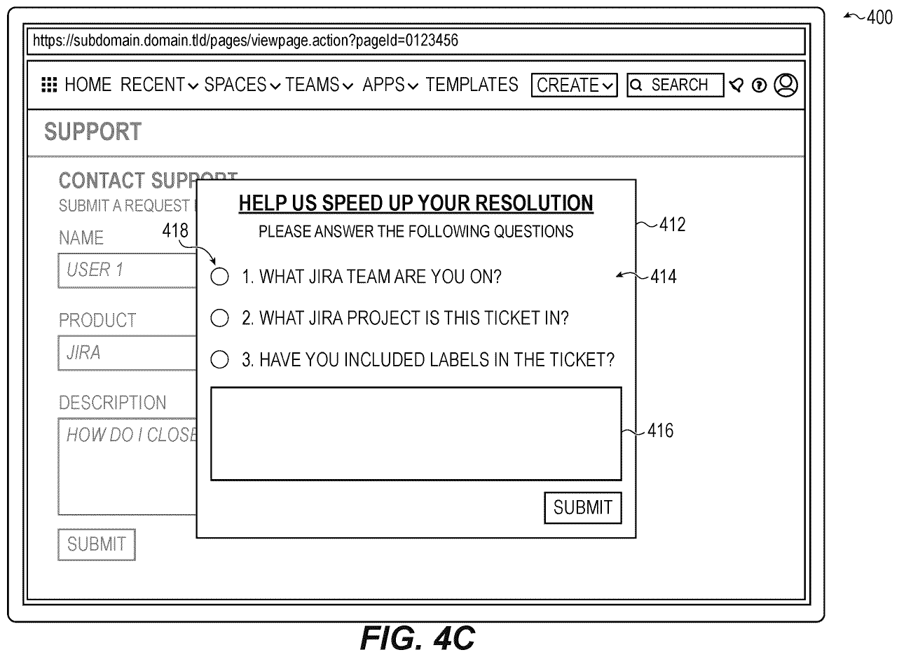

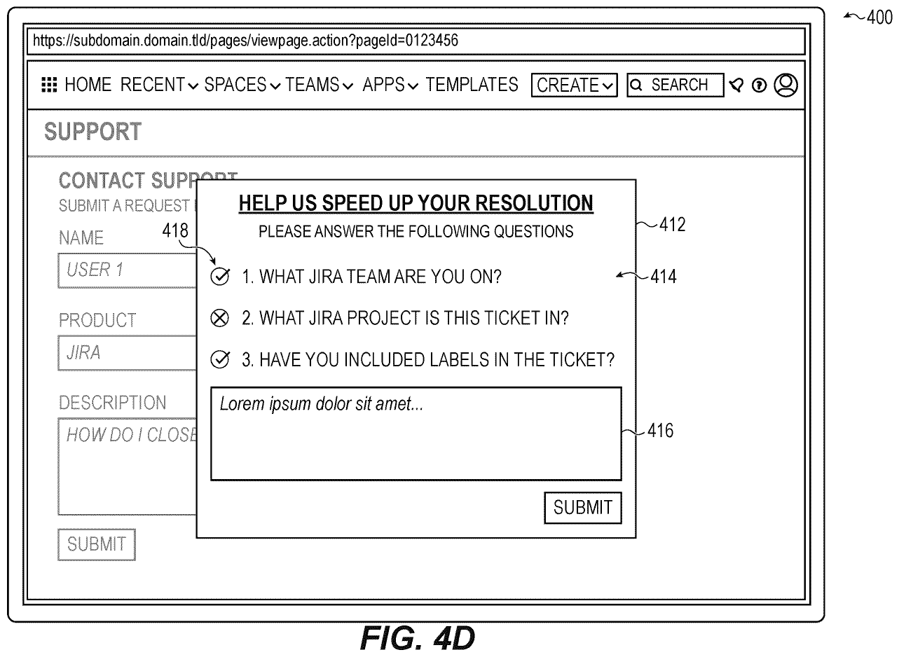

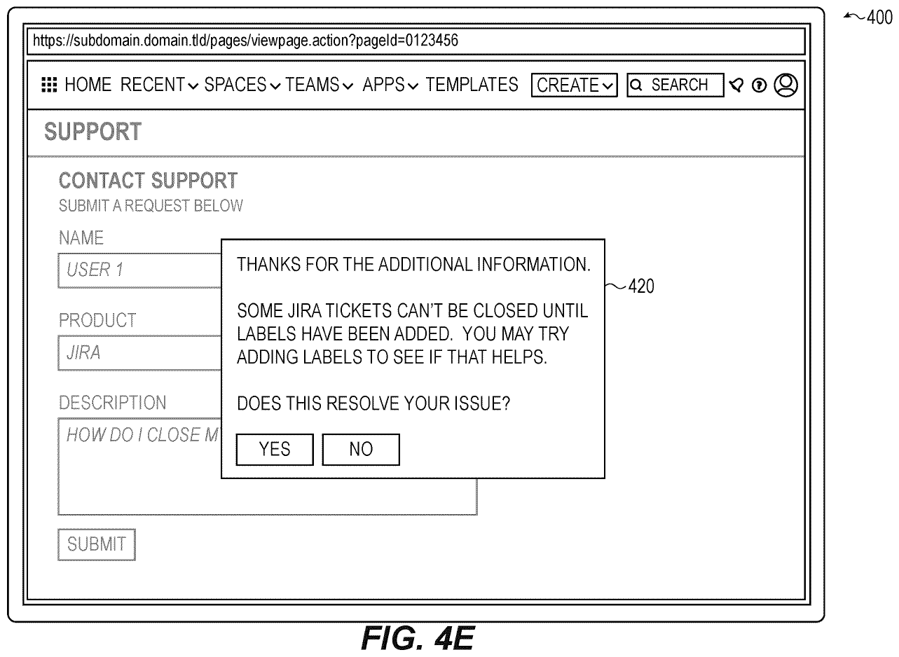

FIGS. 4A-4E illustrate example user interfaces that may be displayed to a user during a support interaction. For example, the user may access a system (e.g., a system that incorporates or accesses support functionality of the support service 203) using a platform frontend application, which may be operating on the hardware of a client device (e.g., a client device 104), also referred to as a platform frontend. The platform application of the platform frontend may include a browser or other web-enabled application that is adapted for use with a web-based platform backend or other similar service over a computer network like the web or internet. In other examples, the platform application of the platform frontend is a dedicated client application that is adapted to communicate with a dedicated backend or other server system via a computer network. As described herein, a system may include platform backends, which may be either web-based servers or dedicated backend servers, depending on the implementation. The frontend application of the platform frontend provides a graphical user interface for the platform, such as the graphical user interfaces 400, 500, 600, which may include content creation interfaces, content viewing interfaces, and other interfaces for interacting with the content and features of the platform backend.

The GUI 400 may be a GUI of a document platform, an issue tracking platform, a codebase platform, or the like, and may include or instantiate a GUI of a support user interface, as described herein. In some cases, the GUI 400 provides access to and/or instantiates GUIs of multiple different software platforms. The GUI 400 may include selectable elements 402 that provide access to various functions of the software platform(s) that are accessible via the GUI 400, including menus, workspaces, applications, search functionality, or the like. It will be understood that these are merely exemplary, and more, fewer, or different selectable elements may be included in a GUI 400.

The GUI 400 is shown displaying a support user interface 404. The support user interface 404 may be reached by selecting a support option or affordance in the GUI 400. In some cases, the GUI 400 may be a GUI for a dedicated support application platform that is separate from the GUI of other software platforms.

The support user interface 404 may include text input fields that accept user inputs. For example, the support user interface 404 includes a name field 406, a product identifier field 408, and a description field 410. It will be understood that these are merely examples, and more, fewer, or different fields or other GUI elements (e.g., selectable options, radio buttons, etc.) may be provided in order to acquire different types of information. The user may enter information into these fields as part of a support request. FIG. 4B illustrates these fields populated with sample information.

The text input provided in these fields may represent the natural language input that is used to generate data item queries, as described with respect to FIGS. 3A-3B. In some cases, the natural language input includes information from multiple fields (e.g., the name, product, and description fields), while in other examples, the natural language input only includes the input to the description field. In the latter case, information from the other fields may be included as metadata to the natural language input and/or as contextual information that may be used by the support service 203 to generate data item queries, natural language responses, and/or natural language query strings.

After providing information in the fields and optionally selecting a submit button 411 or otherwise initiating the support request, the support service 203 may generate natural language query strings, as described with respect to FIGS. 3A-3B. The support service 203 may then cause any selected natural language query strings to be presented to the user in the GUI 400. FIG. 4C illustrates one example technique for presenting the questions, including a follow-up question object 412. The question object 412 may display the selected natural language query strings 414 (e.g., natural language questions) to the user, and provide an input field 416 for the user's responses. In some cases, the question object 412 may also include indicators 418 that indicate whether the user has answered the questions, as described with respect to FIG. 4D.

FIG. 4D illustrates the question object 412 as the user is entering (or has entered) natural language responses to the questions 414. In some cases, the support service 203 analyzes the natural language input provided in the input field 416 to determine whether the natural language input includes answers to the questions 414. For example, the support service 203 may provide the questions 414 and the natural language input to the input review service 224, which may determine whether the questions were answered (e.g., to a threshold level of confidence). FIG. 4E illustrates the question object 412 after the user has entered a natural language input that is responsive to the follow-up questions 414, and after the natural language input (which may be a partial response) has been analyzed relative to the follow-up questions to determine if the requested information has been provided. As shown in FIG. 4E, the indicators 418 have been updated to reflect whether the desired information was provided in the natural language input. In this example, responsive information was found for the first and third question, and not for the second question. This visual feedback may signal to the user that further information is being requested, and may prompt the user to input the missing information. In some cases, providing the requested information is a prerequisite to proceeding through the support process, while in other cases, a user can simply submit the natural language input and proceed, despite not providing responses to each question.

The support service 203 may analyze the natural language input in real-time, as it is being entered (and/or shortly after it is entered), and may update the status of the indicators 418 in real-time. Thus, the user can easily see when they have satisfied the information requests. In other examples, the support service 203 analyzes the natural language input after it is complete (e.g., after a user has selected a “submit” option), and updates the indicators 418 at that time. If the questions have not all been answered, as determined by the input review service 224, the question object 412 may be displayed with the updated status indicators 418.

As described herein, in some cases, the support service 203 may use an AI agent or generate an AI-based support interaction for support requests (e.g., as an initial attempt to resolve the user's request, or where the support service 203 determines that an automated or AI-based response should be sufficient). FIG. 4E illustrates the GUI 400 displaying an example resolution prompt 420. The resolution prompt 420 may include information that is generated by the support service 203 based on the inputs from the user (e.g., the natural language input and the answers to the follow-up questions), metadata, and optionally other resources such as knowledge base documents. The user may indicate that the resolution prompt 420 resolves their request, at which time the support interaction may end (optionally without generating an issue record for the support request). If the user indicates that the prompt 420 does not resolve their request, the support request may be further processed by a human agent (and an issue record may optionally be generated using the user's inputs).

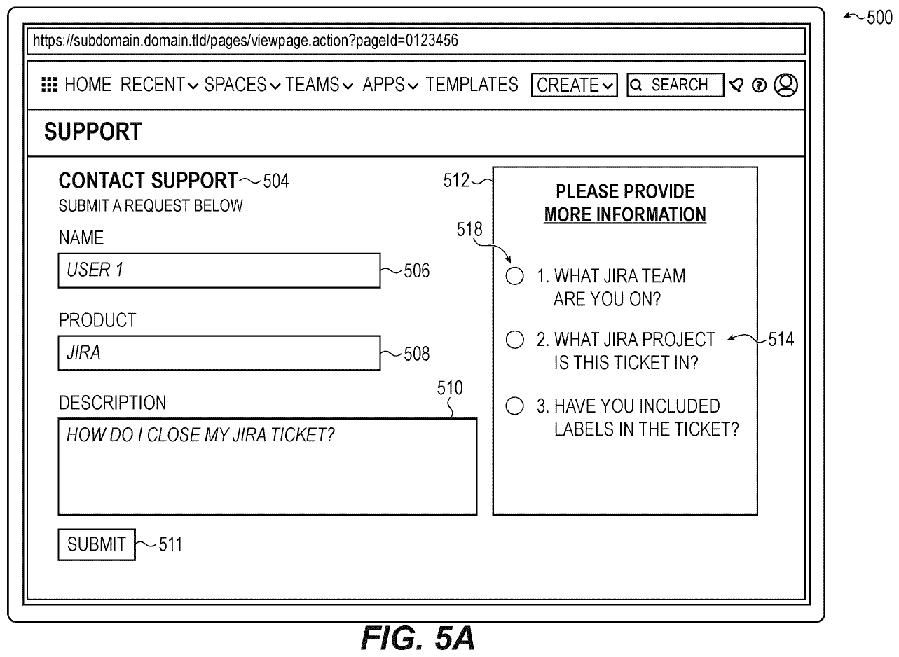

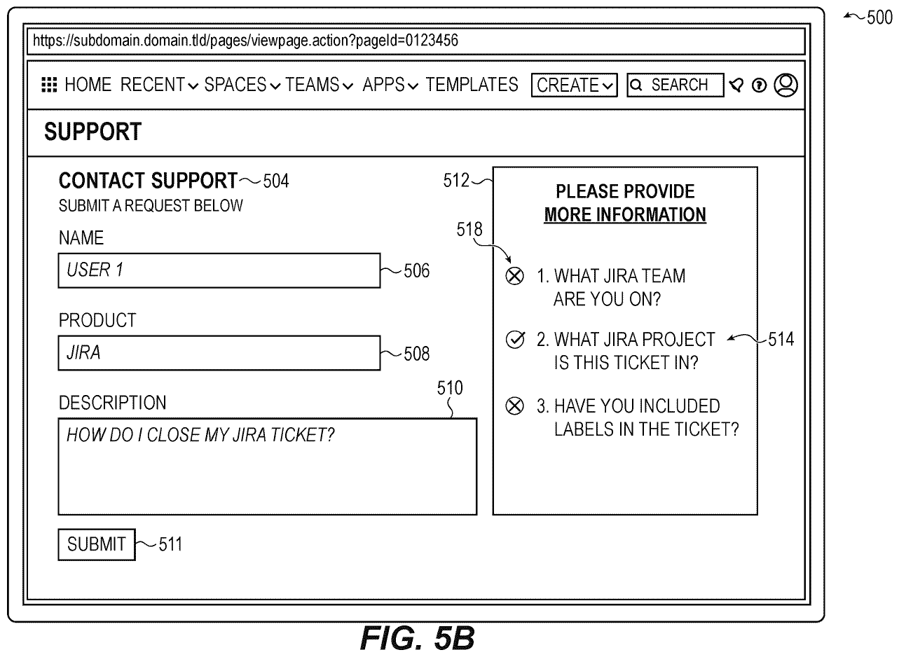

FIGS. 5A-5B illustrate an example GUI 500 for a support service. The GUI 500 may include selectable elements 502 that provide access to various functions of the software platform(s) that are accessible via the GUI 500, including menus, workspaces, applications, search functionality, or the like. It will be understood that these are merely exemplary, and more, fewer, or different selectable elements may be included in a GUI 500. The GUI 500 is shown displaying a support user interface 504. The support user interface 504 may be reached by selecting a support option or affordance in the GUI 500. In some cases, the GUI 500 may be a GUI for a dedicated support application platform that is separate from the GUI of other software platforms.

The GUI 500 illustrates an example in which follow-up questions are displayed in a question object in a panel that may be viewed and/or accessed at the same time as the main input elements of the support interface. In some cases, the follow-up questions are generated and displayed while the user is still providing input, or they may be generated and displayed after the user has provided a complete set of inputs. The support user interface 504 may include text input fields that accept user inputs, such as a name field 506, a product identifier field 508, and a description field 510. It will be understood that these are merely examples, and more, fewer, or different fields or other GUI elements (e.g., selectable options, radio buttons, etc.) may be provided in order to acquire different types of information. The user may enter information into these fields as part of a support request. FIG. 5A illustrates these fields populated with sample information.

The text input provided in these fields may represent the natural language input that is used to generate data item queries, as described with respect to FIGS. 3A-3B. In some cases, the natural language input includes information from multiple fields (e.g., the name, product, and description fields), while in other examples, the natural language input only includes the input to the description field. In the latter case, information from the other fields may be included as metadata to the natural language input and/or as contextual information that may be used by the support service 203 to generate data item queries, natural language responses, and/or natural language query strings.

While the user is providing information in the fields, or after the user has provided a complete initial input (including a natural language input in the description field 510), the support service 203 may generate natural language query strings, as described with respect to FIGS. 3A-3B. The support service 203 may then cause any selected natural language query strings to be presented to the user in the follow-up question object 512. The question object 512 may also include indicators 518 that indicate whether the user has answered the questions. In some cases, the natural language query strings are not generated or are not displayed to the user until after the user selects a submit button 511 or otherwise initiates the support request (e.g., indicating that they have completed the description of the request).

The user may view the follow-up questions 514 in the question object 512, and provide the additional requested information in the description field 510. The support service 203 may analyze the natural language input (e.g., using the input review service 224), including any additional information added after the questions 514 were displayed, and provide indications 518 of whether the requested information was provided. Thus, the user is provided visual feedback that can help prompt the user to provide the requested information.

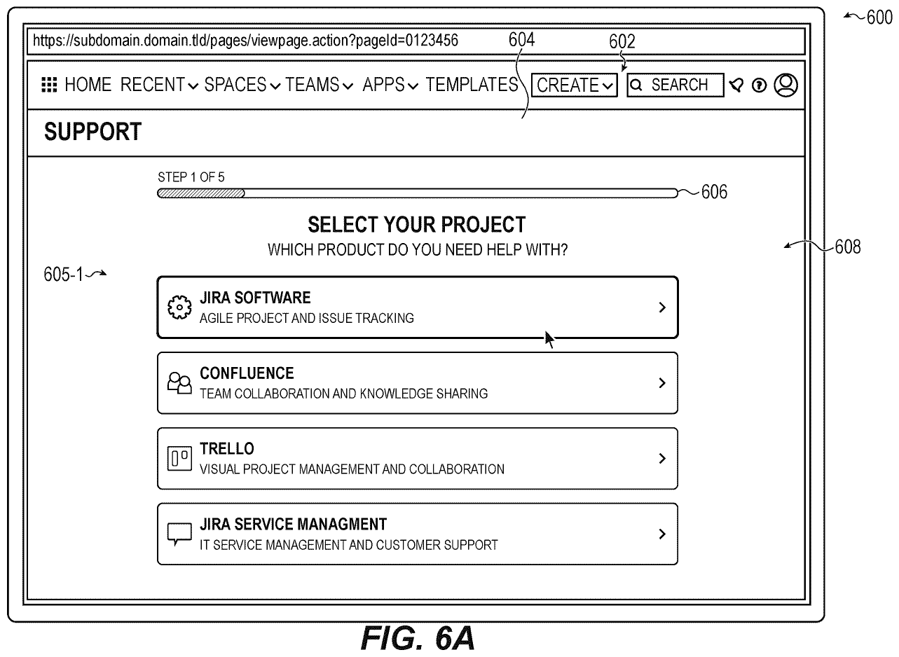

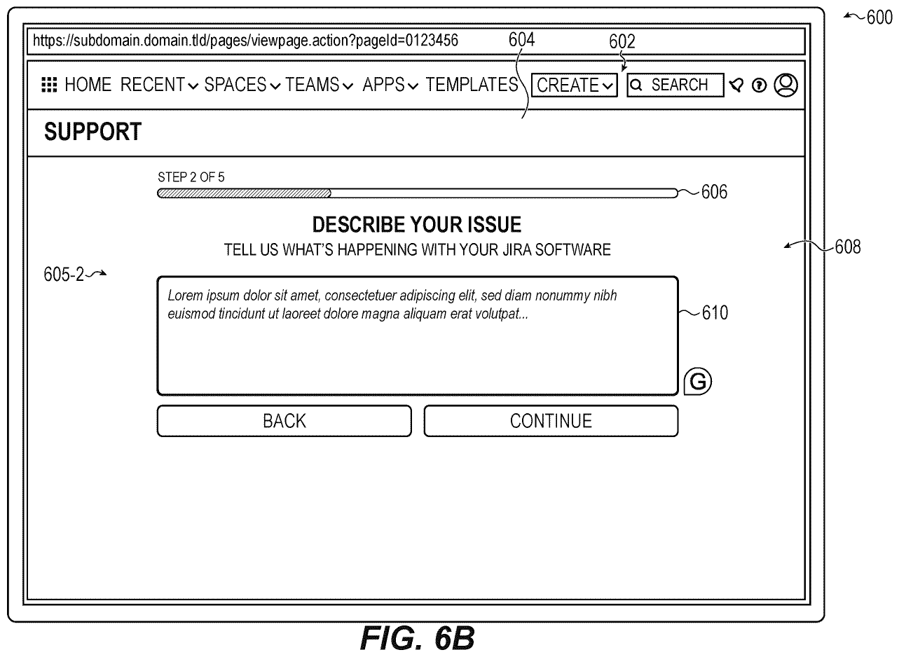

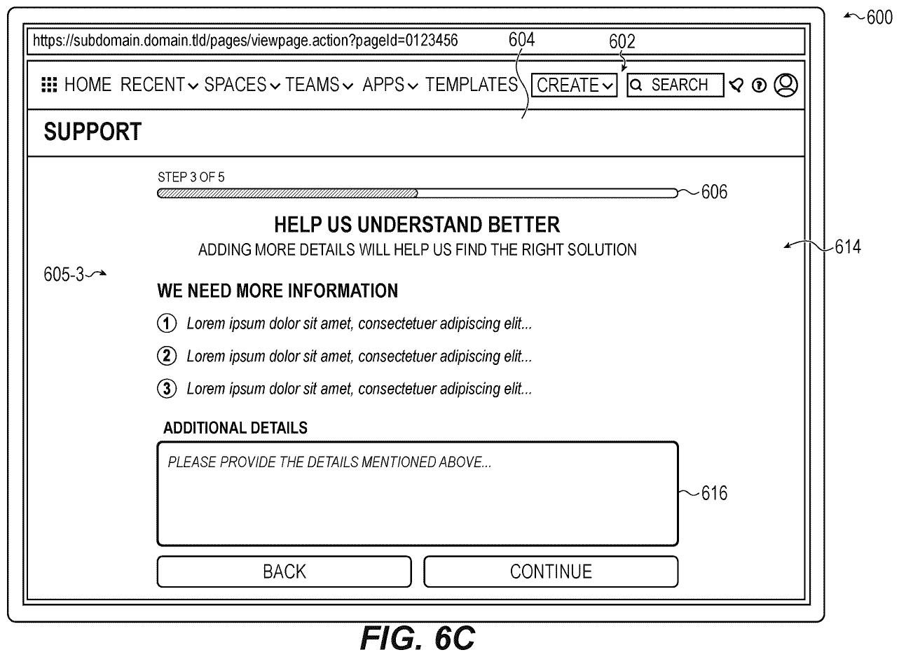

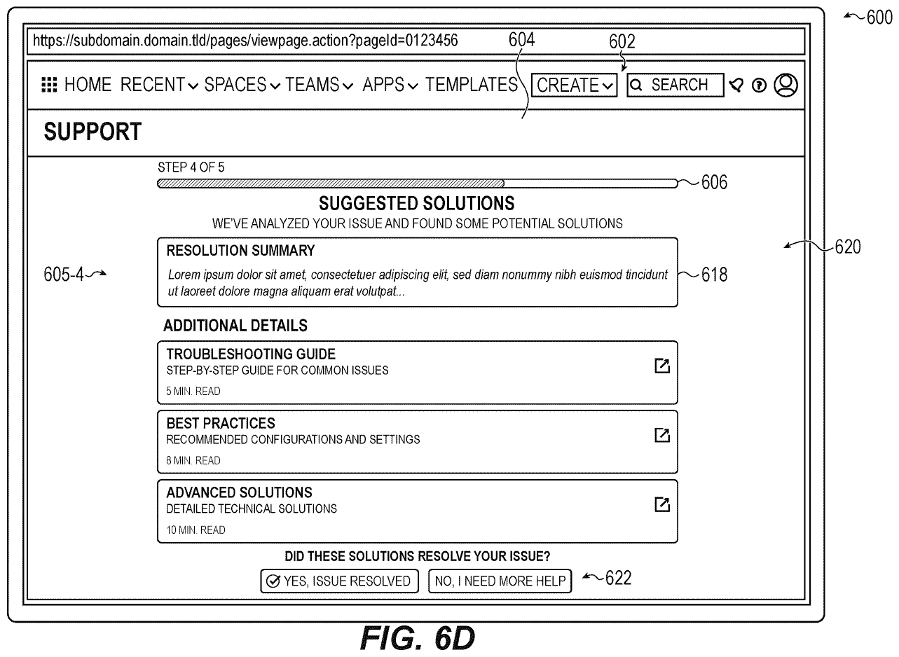

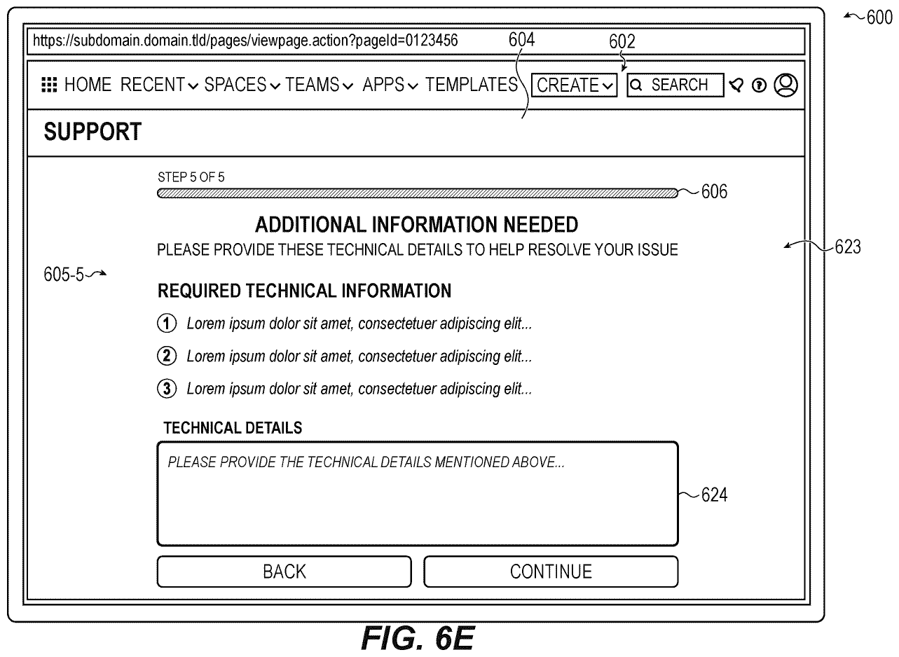

FIGS. 6A-6E illustrate another example GUI 600 for a support service. The GUI 600 may include selectable elements 602 that provide access to various functions of the software platform(s) that are accessible via the GUI 600, including menus, workspaces, applications, search functionality, or the like. It will be understood that these are merely exemplary, and more, fewer, or different selectable elements may be included in a GUI 600. The GUI 600 is shown displaying a support user interface 604. The support user interface 604 may be reached by selecting a support option or affordance in the GUI 600. In some cases, the GUI 600 may be a GUI for a dedicated support application platform that is separate from the GUI of other software platforms. The support user interface 604 may include a status or progress bar 606, which may be updated to indicate the user's progress through a sequence of pages or GUI elements.

The support user interface 604 may provide a guided support experience that leverages the functionality of the support service 203 to seamlessly obtain relevant information from a user. As shown in FIG. 6A, the support user interface 604 displays a first view 605-1 (e.g., which may take the form of a page, panel, window, slide, etc.) that includes a set of support subject selection elements 608. The support subject selection elements 608 may correspond to a subject or topic for which the support service 203 provides support. As shown, the selection elements 608 relate to software platforms, though this is merely an example, and any subjects may be represented by the selection elements 608. The user may select a selection element 608 (e.g., by clicking), which may cause the support user interface 604 to advance to a second view 605-2, as shown in FIG. 6B. Additionally, information associated with the selection may be used by the support service 203. For example, information associated with the user selection may be incorporated into input metadata (e.g., metadata 304). The information may also be used to select a knowledge base to search to identify data item queries (e.g., by the knowledge base service 310).

The second view 605-2 includes a description field 610 in which the user provides a natural language input describing their support request. Once the user has entered the description (and/or while the user is entering the description), the support service may use the natural language input to generate data item queries, as described herein.

FIG. 6C illustrates a third view 605-3, which displays the natural language query strings 614 generated by the support service 203 in response to the natural language input. An input field 616 is also provided for the user's responses to the natural language query strings 614. Once the user submits responses (and if no further follow-up questions have been generated based on the updated input), a fourth view 605-4 (FIG. 6D) may be displayed.

The fourth view 605-4 provides a suggested resolution 618 and optionally additional information or resources 620 that the user may consult to attempt to resolve their request. In some cases, the resources 620 may be knowledge base documents (e.g., identified by the knowledge base service 310), articles, internet links, or any other suitable resource. As described above, the suggested resolution 618 and the resources 620 may be generated by the support service 203 as part of an automated support process (e.g., it is not a direct response from a human agent). As such, the fourth view 605-4 may include confirmation elements 622 that a user can select to indicate whether their request has been resolved. If the request has not been resolved, the support service 203 may initiate a human-mediated support interaction.

As described herein, the automated or AI-based support operations may have different capabilities and/or limitations than a human support agent, and the support service 203 may provide different follow-up questions depending on whether the support request interaction type is an automated support type (e.g., an AI-based support operation) or a human-based support type. Thus, when a support interaction transitions from an automated support type to a human-based support type, the support service 203 may generate an additional or different set of questions, reflecting the new or different functions, authorizations, or other capabilities of the human-based support type.

FIG. 6E illustrates a fifth view 605-5 in which additional follow-up questions 623 are presented to the user, along with an input field 624 to accept responses to the questions 623. The additional follow-up questions 623 may include questions (and/or be configured to elicit information) that were not relevant or useful for an automated support interaction type. In some cases, the additional follow-up questions 623 are generated based on the initial natural language input (e.g., provided in the input field 610), as well as responses to the follow-up questions (e.g., provided in the input field 616). In some cases, the text of any follow-up questions that were presented to the user and/or answered are also used as inputs to the support service 203 to generate the additional follow-up questions 623.

The user may provide answers to the additional follow-up questions 623. The support interaction may then proceed to a next operation. For example, an issue record may be generated and stored in association with an issue tracking system, where the issue record includes the user inputs (e.g., natural language inputs), data extracted and/or generated from the user inputs, metadata associated with the support request, or the like. Additionally or alternatively, the support request may be referred to a human agent, as described herein, and support request information (e.g., user inputs (e.g., natural language inputs), data extracted and/or generated from the user inputs, metadata associated with the support request, etc.) may be provided to the human agent in order to facilitate resolution of the support request.

FIG. 7 depicts an example process 700 for generating questions in response to user input. The process 700 (e.g., a computer-implemented method) may be performed by a support service, such as the support service 203, in conjunction with a generative service and/or any other platforms, systems, or services described herein.

At operation 702, a natural language input may be received from a graphical user interface of a client application operating on a client device. The natural language input may be associated with a support request, as described herein.

At operation 704, the natural language input may be analyzed (e.g., using a support-request analysis engine) to determine a sufficiency condition. Determining the sufficiency condition may include providing the natural language input as an input to a machine learning model that is trained on a dataset including respective natural language inputs associated with respective sufficiency determinations.

In accordance with a determination that the sufficiency condition is not satisfied, at operation 706, one or more sets of recommended data item queries are generated. The data item queries may be generated by a data item query service 222, as described herein. For example, requests may be submitted to one or more services to obtain one or more sets of recommended data item queries. The services may include a knowledge-base service, which may identify a knowledge base document of a set of knowledge base documents, generate a data item query prompt comprising predetermined first query prompt text, text from the knowledge base document, and the natural language input, provide the data item query prompt to a generative output engine, and receive, from the generative output engine, the second set of recommend data item queries.

At operation 708, the recommended data item queries are analyzed to identify a subset of data item queries for which answers were not included in the natural language input. Identifying the data item queries for which answers were not included may include generating a prompt comprising predetermined second query prompt text, the recommended data item query, and the natural language input, providing the second prompt to the generative output engine, receiving, from a generative output engine, a generative response, and analyzing the generative response to determine whether an answer to the recommended data item query was included in the natural language input.

At operation 710, recommended data item queries are ranked based on the relevance of the recommended data item queries to a subject of the natural language input. The ranking may include generating a prompt comprising predetermined query prompt text, text from the group of recommended data item queries, and the natural language input, providing the first prompt to a generative output engine, and receiving, from the generative output engine, a ranking of the recommended data item queries of the group of recommend data item queries.

At operation 712, the data item queries may be filtered. For example, the data item queries may be filtered to remove duplicate data item queries (and/or combine them), remove data item queries that are not suitable for a particular support interaction type, etc.

At operation 714, natural language query strings are generated for eliciting, from the user, answers to the data item queries. Generating the natural language query strings may include generating a question generation prompt comprising predetermined query prompt text and the data item query, providing the question generation prompt to a generative output engine, and receiving the natural language query string from the generative output engine.

At operation 716, the natural language query strings may be provided to the user. A user may then provide responses to the natural language query strings. In some cases, some or all of the operations of the process 700 are repeated, as described herein, to elicit additional information from the user.

At operation 718, an issue record is optionally generated. The issue record may include user-supplied answers to the data item query, the initial natural language input, and/or other information associated with the support request. The issue record may be stored in association with an issue tracking system.

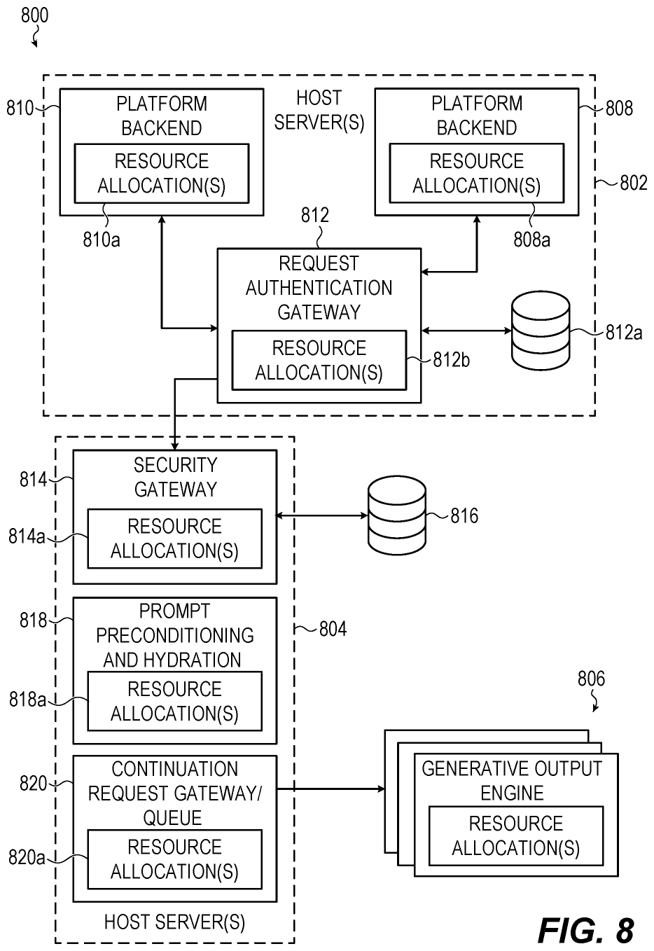

FIG. 8 depicts a system diagram and network/communication architectures that may support a system as described herein. The system 800 includes a first set of host servers 802 associated with one or more software platform backends. These software platform backends can be communicably coupled to a second set of host servers 804 purpose configured to process requests and responses to and from one or more generative output engines 806.

Specifically, the first set of host servers 802 (which, as described above can include processors, memory, storage, network communications, and any other suitable physical hardware cooperating to instantiate software) can allocate certain resources to instantiate a first and second platform backend, such as a first platform backend 808 and a second platform backend 810. Each of these respective backends can be instantiated by cooperation of processing and memory resources associated to each respective backend. As illustrated, such dedicated resources are identified as the resource allocations 808a and the resource allocations 810a.

Each of these platform backends can be communicably coupled to an authentication gateway 812 configured to verify, by querying a permissions table, directory service, or other authentication system (represented by the database 812a) whether a particular request for generative output from a particular user is authorized. Specifically, the second platform backend 810 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 812 can deny the request for insufficient permissions. This example is merely one and is not intended to be limiting; many possible authorization and authentication operations can be performed by the authentication gateway 812. The authentication gateway 812 may be supported by physical hardware resources, such as a processor and memory, represented by the resource allocations 812b.

Once the authentication gateway 812 determines that a request from a user of either platform is authorized to access data or resources implicated in service that request, the request may be passed to a security gateway 814, which may be a software instance supported by physical hardware identified in FIG. 8 as the resource allocations 814a. The security gateway 814 may be configured to determine whether the request itself conforms to one or more policies or rules (data and/or executable representations of which may be stored in a database 816) established by the organization. For example, the organization may prohibit executing prompts for offensive content, value-incompatible content, personally identifying information, health information, trade secret information, unreleased product information, secret project information, and the like. In other cases, a request may be denied by the security gateway 814 if the prompt requests are beyond a threshold quantity of data.

Once a particular user-initiated prompt has been sufficiently authorized and cleared against organization-specific generative output rules, the request/prompt can be passed to a preconditioning and hydration service 818 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 818 can be a software instance supported by physical hardware represented by the resource allocations 818a. In some implementations, the hydration service 818 may also be used to rehydrate personally identifiable information (PII) or other potentially sensitive data that has been extracted from a request or data exchange in the system.

Once a prompt has been modified, replaced, or hydrated by the preconditioning and hydration service 818, it may be passed to an output gateway 820 (also referred to as a continuation gateway or an output queue). The output gateway 820 may be responsible for enqueuing and/or ordering different requests from different users or different software platforms based on priority, time order, or other metrics. The output gateway 820 can also serve to meter requests to the generative output engines 806.

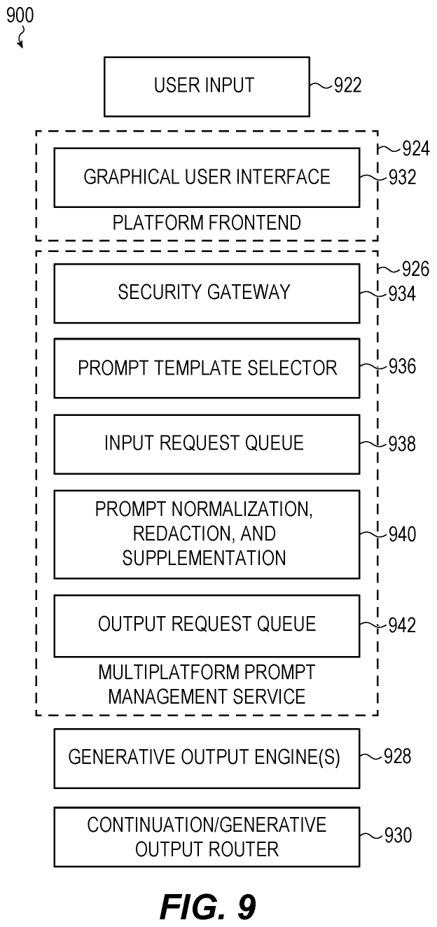

FIG. 9 depicts a functional system diagram of the system 900. In particular, the system 900 is configured to operate as a multiplatform prompt management service supporting and ordering requests from multiple users across multiple platforms, and/or from multiple services. In particular, a user input 922 may be received at a platform frontend 924. The platform frontend 924 passes the input to a prompt management service 926 that formalizes a prompt suitable for input to a generative output engine 928, which in turn can provide its output to an output router 960 that may direct generative output to a suitable destination. For example, the output router 960 may execute API requests generated by the generative output engine 928, may submit text responses back to the platform frontend 924, may wrap a text output of the generative output engine 928 in an API request to update a backend of the platform associated with the platform frontend 924, or may perform other operations.

Specifically, the user input 922 (which may be an engagement with a button, typed text input, spoken input, chat box input, and the like) can be provided to a GUI 932 of the platform frontend 924. The GUI 932 can be communicably coupled (optionally via another service, such as a support service) to a security gateway 934 of the prompt management service 926 that may be configured to determine whether the user input 922 is authorized to execute and/or complies with organization-specific rules.

The security gateway 934 may provide output to a prompt selector 936 which can be configured to select a prompt template from a database of preconfigured prompts, templatized prompts, or engineered templatized prompts. Once the raw user input is transformed into a string prompt, the prompt may be provided as input to a request queue 938 that orders different user request for input from the generative output engine 928. Output of the request queue 938 can be provided as input to a prompt hydrator 940 configured to populate template fields, add context identifiers, supplement the prompt, and perform other normalization operations described herein. In other cases, the prompt hydrator 940 can be configured to segment a single prompt into multiple discrete requests, which may be interdependent or may be independent.

Thereafter, the modified prompt(s) can be provided as input to an output queue at 942 that may serve to meter inputs provided to the generative output engine 928.

These foregoing embodiments depicted in FIGS. 8-9 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

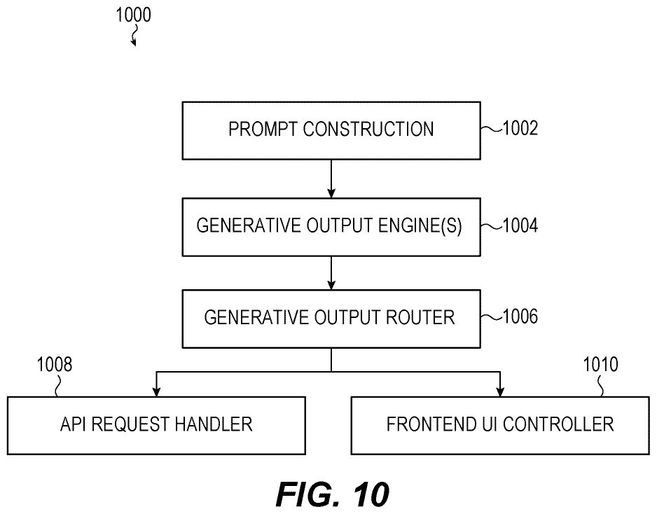

Although many constructions are possible, FIG. 10 depicts a simplified system diagram and data processing pipeline as described herein. The system 1000 receives user input, and constructs a prompt therefrom at operation 1002. After constructing a suitable prompt, and populating template fields, selecting appropriate instructions and examples for an LLM to continue, the modified constructed prompt is provided as input to a generative output engine 1004. A continuation from the generative output engine 1004 is provided as input to a router 1006 configured to classify the output of the generative output engine 1004 as being directed to one or more destinations. For example, the router 1006 may determine that a particular generative output is an API request that should be executed against a particular API (e.g., such as an API of a system or platform as described herein). In this example, the router 1006 may direct the output to an API request handler 1008. In another example, the router 1006 may determine that an automation execution including a generative output may be suitably directed to a GUI/frontend.

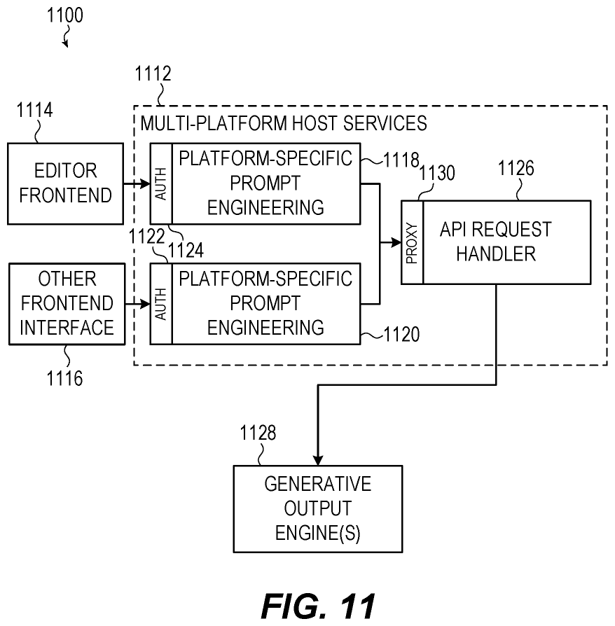

Another example architecture is shown in FIG. 11, illustrating a system providing prompt management, and in particular multiplatform prompt management as a service. The system 1100 is instantiated over cloud resources, which may be provisioned from a pool of resources in one or more locations (e.g., datacenters). In the illustrated embodiment, the provisioned resources are identified as the multi-platform host services 1112.

The multi-platform host services 1112 can receive input from one or more users in a variety of ways. For example, some users may provide input via an editor region 1114 of a frontend, such as described above. Other users may provide input by engaging with other user interface elements 1116 unrelated to common or shared features across multiple platforms. Specifically, the second user may provide input to the multi-platform host services 1112 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1112 can include multiple software instances or microservices each configured to receive user inputs and/or proposed prompts and configured to provide, as output, an engineered prompt. In many cases, these instances—shown in the figure as the platform-specific prompt engineering services 1118, 1120—can be configured to wrap proposed prompts within engineered prompts retrieved from a database such as described above.

In many cases, the platform-specific prompt engineering services 1118, 1120 can be each configured to authenticate requests received from various sources. In other cases, requests from editor regions or other user interface elements of particular frontends can be first received by one or more authenticator instances, such as the authentication instances 1122, 1124. In other cases, a single centralized authentication service can provide authentication as a service to each request before it is forwarded to the platform-specific prompt engineering services 1118, 1120.

Once a prompt has been engineered/supplemented by one of the platform-specific prompt engineering services 1118, 1120, it may be passed to a request queue/API request handler 1126 configured to generate an API request directed to a generative output engine 1128 including appropriate API tokens and the engineered prompt as a portion of the body of the API request. In some cases, a service proxy 1130 can interpose the platform-specific prompt engineering services 1118, 1120 and the request queue/API request handler 1126, so as to further modify or validate prompts prior to wrapping those prompts in an API call to the generative output engine 1128 by the request queue/API request handler 1126 although this is not required of all embodiments.

These foregoing embodiments depicted in FIGS. 8-11 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

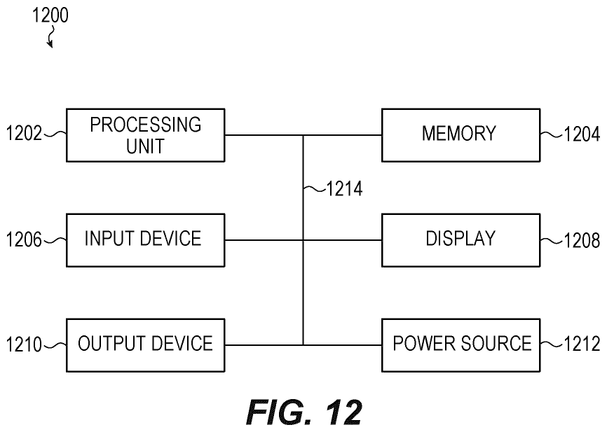

FIG. 12 shows a sample electrical block diagram of an electronic device 1200 that may perform the operations described herein. The electronic device 1200 may in some cases take the form of any of the electronic devices described with reference to FIGS. 1-11, including client devices, and/or servers or other computing devices associated with the system 100. The electronic device 1200 can include one or more of a processing unit 1202, a memory 1204 or storage device, input devices 1206, a display 1208, output devices 1210, and a power source 1212. In some cases, various implementations of the electronic device 1200 may lack some or all of these components and/or include additional or alternative components.

The processing unit 1202 can control some or all of the operations of the electronic device 1200. The processing unit 1202 can communicate, either directly or indirectly, with some or all of the components of the electronic device 1200. For example, a system bus or other communication mechanism 1214 can provide communication between the processing unit 1202, the power source 1212, the memory 1204, the input device(s) 1206, and the output device(s) 1210. The processing unit 1202 may be operably coupled to the computer-readable memory 1204, which stores computer-readable instructions. The computer-readable instructions, when executed by the processing unit 1202 may cause the device or system to perform operations described herein with respect to the example embodiments and processes.

The processing unit 1202 can be implemented as any electronic device capable of processing, receiving, or transmitting data or instructions. For example, the processing unit 1202 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1200 can be controlled by multiple processing units. For example, select components of the electronic device 1200 (e.g., an input device 1206) may be controlled by a first processing unit and other components of the electronic device 1200 (e.g., the display 1208) may be controlled by a second processing unit, where the first and second processing units may or may not be in communication with each other.

The power source 1212 can be implemented with any device capable of providing energy to the electronic device 1200. For example, the power source 1212 may be one or more batteries or rechargeable batteries. Additionally, or alternatively, the power source 1212 can be a power connector or power cord that connects the electronic device 1200 to another power source, such as a wall outlet.

The memory 1204 can store electronic data that can be used by the electronic device 1200. For example, the memory 1204 can store electronic data or content such as, for example, audio and video files, documents and applications, device settings and user preferences, timing signals, control signals, and data structures or databases. The memory 1204 can be configured as any type of memory. By way of example only, the memory 1204 can be implemented as random access memory, read-only memory, flash memory, removable memory, other types of storage elements, or combinations of such devices.

In various embodiments, the display 1208 provides a graphical output, for example associated with an operating system, user interface, and/or applications of the electronic device 1200 (e.g., a chat user interface, an issue-tracking user interface, an issue-discovery user interface, etc.). In one embodiment, the display 1208 includes one or more sensors and is configured as a touch-sensitive (e.g., single-touch, multi-touch) and/or force-sensitive display to receive inputs from a user. For example, the display 1208 may be integrated with a touch sensor (e.g., a capacitive touch sensor) and/or a force sensor to provide a touch-and/or force-sensitive display. The display 1208 is operably coupled to the processing unit 1202 of the electronic device 1200.

The display 1208 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1208 is positioned beneath and viewable through a cover that forms at least a portion of an enclosure of the electronic device 1200.

In various embodiments, the input devices 1206 may include any suitable components for detecting inputs. Examples of input devices 1206 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1206 may be configured to detect one or more particular types of input and provide a signal (e.g., an input signal) corresponding to the detected input. The signal may be provided, for example, to the processing unit 1202.

As discussed above, in some cases, the input device(s) 1206 include a touch sensor (e.g., a capacitive touch sensor) integrated with the display 1208 to provide a touch-sensitive display. Similarly, in some cases, the input device(s) 1206 include a force sensor (e.g., a capacitive force sensor) integrated with the display 1208 to provide a force-sensitive display.

The output devices 1210 may include any suitable components for providing outputs. Examples of output devices 1210 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1210 may be configured to receive one or more signals (e.g., an output signal provided by the processing unit 1202) and provide an output corresponding to the signal.

In some cases, input devices 1206 and output devices 1210 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1202 may be operably coupled to the input devices 1206 and the output devices 1210. The processing unit 1202 may be adapted to exchange signals with the input devices 1206 and the output devices 1210. For example, the processing unit 1202 may receive an input signal from an input device 1206 that corresponds to an input detected by the input device 1206. The processing unit 1202 may interpret the received input signal to determine whether to provide and/or change one or more outputs in response to the input signal. The processing unit 1202 may then send an output signal to one or more of the output devices 1210, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method of generating questions in response to a user input, the method comprising:
receiving a natural language input from a graphical user interface of a client application operating on a client device;
analyzing the natural language input using a support-request analysis engine to determine a sufficiency condition;
in accordance with a determination that the sufficiency condition is not satisfied, generating a set of recommended data item queries;
analyzing the set of recommended data item queries to identify a group of data item queries for which answers were not included in the natural language input;
analyzing the identified group of data item queries to identify redundant data item queries that are directed to eliciting same information;
generating a representative data item query for the redundant data item queries;
including the representative data item query in the identified group of data item queries;
for a data item query of the identified group of data item queries, generating a natural language query string for eliciting, from a user, an answer to the data item query, comprising:
generating a question generation prompt comprising predetermined query prompt text and the data item query;
providing the question generation prompt to a generative output engine; and
receiving the natural language query string from the generative output engine;
causing display of the natural language query string to the user;
receiving, from the user, a response including the answer to the data item query;
generating an issue record including the answer to the data item query; and
storing the issue record in association with an issue tracking system.

2. The computer-implemented method of claim 1, wherein:
the predetermined query prompt text is predetermined first query prompt text; and
generating the representative data item query for the redundant data item queries comprises:
generating a representative data item query prompt comprising predetermined second query prompt text and text from the redundant data item queries;
providing the representative data item query prompt to the generative output engine; and
receiving the representative data item query from the generative output engine.

3. The computer-implemented method of claim 1, further comprising:
removing, from the identified group of data item queries, data item queries that are not supported by a support-request interaction type associated with the natural language input, thereby creating a list of candidate data item queries; and
selecting the data item query from the list of candidate data item queries.

4. The computer-implemented method of claim 1, wherein:
the predetermined query prompt text is predetermined first query prompt text; and
generating the set of recommended data item queries comprises:
submitting a first request to a first service to obtain a first subset of recommended data item queries;
submitting a second request to a knowledge-base service to obtain a second subset of recommended data item queries, the second subset of recommended data item queries generated by:
identifying a knowledge base document of a set of knowledge base documents;
generating a data item query prompt comprising predetermined second query prompt text, text from the knowledge base document, and the natural language input;
providing the data item query prompt to a generative output engine; and
receiving, from the generative output engine, the second subset of recommend data item queries; and
submitting a third request to a second service to obtain a third subset of recommended data item queries, the third subset of recommended data item queries associated with a term included in the natural language input.

5. The computer-implemented method of claim 4, wherein:
the method further comprises receiving an identifier of the client application; and
the first service selects the first set of recommended data item queries based on the identifier of the client application.

6. The computer-implemented method of claim 1, wherein analyzing the natural language input to determine the sufficiency condition comprises providing the natural language input as an input to a machine learning model that is trained on a dataset including respective natural language inputs associated with respective sufficiency determinations.

7. The computer-implemented method of claim 1, wherein:
the predetermined query prompt text is predetermined first query prompt text; and
the method further comprises, prior to generating the natural language query string for eliciting the answer to the data item query:
ranking the identified group of data item queries for which answers were not included in the natural language input based on relevance of the data item queries to a subject of the natural language input, comprising:
generating a relevance inquiry prompt comprising predetermined second query prompt text, text from the identified group of data item queries, and the natural language input;
providing the relevance inquiry prompt to the generative output engine; and
receiving, from the generative output engine, a ranking of the data item queries of the identified group of data item queries; and
selecting, based on the ranking, at least one data item query from the identified group of data item queries as the data item query.

8. A computer-implemented method of generating questions in response to a user input, the method comprising:
receiving a natural language input from a graphical user interface of a client application operating on a client device;
obtaining a group of recommended data item queries, the group of recommended data item queries including text extracted from at least one knowledge base document of a set of knowledge base documents;
ranking the group of recommended data item queries based on a relevance of the recommended data item queries to a subject of the natural language input, comprising:
generating a first prompt comprising predetermined first query prompt text, text from the group of recommended data item queries, and the natural language input;
providing the first prompt to a generative output engine; and
receiving, from the generative output engine, a ranking of the recommended data item queries of the group of recommend data item queries;
selecting, based on the ranking, at least one data item query from the recommended data item queries;
for the selected at least one data item query, generating a natural language query string for eliciting, from a user, an answer to the at least one data item query, comprising:
generating a question generation prompt comprising predetermined second query prompt text and the at least one data item query;
providing the question generation prompt to the generative output engine; and
receiving the natural language query string from the generative output engine;
causing display of the natural language query string to the user;
receiving, from the user, a response including the answer to the at least one data item query; and
storing the answer to the at least one data item query in association with the natural language input.

9. The computer-implemented method of claim 8, wherein obtaining the group of recommended data item queries comprises:
identifying a knowledge base document of the set of knowledge base documents;
generating a data item query prompt comprising predetermined third query prompt text, text from the knowledge base document, and the natural language input;
providing the data item query prompt to the generative output engine; and
receiving, from the generative output engine, at least a subset of the group of recommend data item queries.

10. The computer-implemented method of claim 8, further comprising, prior to ranking the group of recommended data item queries, removing, from the group of recommended data item queries, data item queries for which answers were included in the natural language input.

11. The computer-implemented method of claim 8, further comprising, prior to ranking the group of recommended data item queries:
analyzing the group of recommended data item queries to identify redundant data item queries that are directed to eliciting same information;
generating a representative data item query for the redundant data item queries; and
including the representative data item query in the group of recommended data item queries.

12. The computer-implemented method of claim 11, wherein generating the representative data item query for the redundant data item queries comprises:
generating a representative data item query prompt comprising predetermined third query prompt text and text from the redundant data item queries;
providing the representative data item query prompt to the generative output engine; and
receiving the representative data item query from the generative output engine.

13. The computer-implemented method of claim 8, wherein the graphical user interface is a support request graphical user interface associated with the client application.

14. The computer-implemented method of claim 8, further comprising:
generating an issue record including the answer to the at least one data item query; and
storing the issue record in association with an issue tracking system.

15. A system of a support platform, the system comprising:
one or more processing units;
computer readable memory storing computer readable instructions that when executed by the one or more processing units cause the system to:
receive a natural language input, the natural language input provided to a support request graphical user interface of a client application operating on a client device;
obtain a set of recommended data item queries;
analyze the set of recommended data item queries to identify a subset of data item queries for which answers were not included in the natural language input, the analyzing comprising, for a recommended data item query of the set of recommended data item queries:
generating a second prompt comprising predetermined query prompt text, the recommended data item query, and the natural language input;
providing the second prompt to a generative output engine;
receiving, from the generative output engine, a generative response; and
analyzing the generative response to determine whether an answer to the recommended data item query was included in the natural language input;
generate a composite data item query from at least a first data item query and a second data item query from the subset of data item queries, the composite data item query configured to elicit information for the first data item query and the second data item query;
generate a natural language query string for eliciting an answer to the composite data item query;
cause display of the natural language query string in the support request graphical user interface;
receive a response including the answer to the composite data item query; and
store the answer to the composite data item query in association with the natural language input.

16. The system of claim 15, wherein:
generating the natural language query string comprises:
generating a question generation prompt comprising predetermined second query prompt text and the composite data item query;
providing the question generation prompt to the generative output engine; and
receiving the natural language query string from the generative output engine.

17. The system of claim 15, wherein obtaining the set of recommended data item queries comprises:
receiving an identifier of the client application; and
submitting a request to a service to obtain the set of recommended data item queries, the request including the identifier of the client application; and
the service selects the set of recommended data item queries based on the identifier of the client application.

18. The system of claim 17, wherein obtaining the set of recommended data item queries further comprises submitting an additional request to an additional service to obtain additional recommended data item queries, the additional recommended data item queries associated with a term included in the natural language input.

19. The system of claim 15, wherein the computer readable instructions further cause the system to:
generate an issue record including the answer to the recommended data item query; and
store the issue record in association with an issue tracking system.

20. The system of claim 15, wherein the computer readable instructions further cause the system to, prior to analyzing the set of recommended data item queries to identify the subset of data item queries for which answers were not included in the natural language input, remove, from the set of recommended data item queries, recommended data item queries that are not supported by a support request interaction type associated with the natural language input.
